(19) United States
(12) Patent Application Publication
(10) Pub. No.: US 2003/0018668 A1
(43) Pub. Date: Jan. 23, 2003

(54) Enhanced transcoding of structured documents through use of annotation techniques

(75) Inventors: Kathryn H. Britton, Chapel Hill, NC (US); Roderick C. Henderson, Greensboro, NC (US); John R. Hind, Raleigh, NC (US); Steven D. Ims, Apex, NC (US); Max A. McMullen, Jericho, VT (US); Christopher R. Seekamp, Boca Raton, FL (US); Brad B. Topol, Raleigh, NC (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY

(21) Appl. No.: 09/910,083

(22) Filed: Jul. 20, 2001

(51) Int. Cl. G06F 15/00

(52) U.S. Cl. 707/513; 370/513; 707/512

(57) ABSTRACT

Methods, systems, and computer program products for improving the transcoding operations which are performed on structured documents (such as those encoded in the Hypertext Markup Language, or “HTML”) through use of annotations. Source documents may be annotated according to one or more types of annotations. Representative types of annotations direct an annotation engine to perform selective clipping of document content, provide enhanced HTML form support, request node and/or attribute replacement or the insertion of HTML or other rendered markup syntax, and direct a transcoding engine to provide fine-grained transcoding preference support (such as controlling transcoding of tables on a per-row or per-column basis). The disclosed techniques may be used with statically-generated document content and with dynamically-generated content. Annotation is performed as a separate step preceding transcoding, and a modified document resulting from processing annotations may therefore be re-used for multiple different transcoding operations.

### BACKGROUND OF THE INVENTION

1. Field of the Invention

The present invention relates to computer systems, and deals more particularly with methods, systems, and computer program products for improving the transcoding operations which are performed on structured documents (such as those encoded in the Hypertext Markup Language, or “HTML”) through use of annotations.

2. Description of the Related Art

“Transcoding” is a technique well known in the art. In general, a transcoder translates or transforms the content of a document or file, resulting in creation of a different document or file. In the Internet and World Wide Web environments, transcoding is used in a number of ways. As one example, transcoding may be used to transform a full-color graphic image that is embedded within a Web document into a grayscale image, in order to reduce the size of the information content before transmitting it from a server to a client that has requested the document. As another example, an Extensible Markup Language (“XML”) document may be translated into an HTML document before transmitting it to a client.

Transcoding is commonly used for adapting and tailoring Web content such as that contained in HTML pages or XML documents for presentation on pervasive computing devices, and is a methodology that has shown itself to have great potential as a means of enabling Web content to be displayed on a myriad of wireless devices. In fact, the WebSphere Transcoding Publisher product from the International Business Machines Corporation (“IBM”®) today supports the ability to automatically transcode HTML to several other markup languages, including Wireless Markup Language (“WML”), Handheld Device Markup Language (“HDML”) and i-mode formats. (“IBM” is a registered trademark.)

Automatic transcoding removes from the customer the tedious process of having to learn the vast number of emerging markup languages developed for pervasive computing devices and also the burden of manually converting existing HTML content into each of the new markup formats. In addition, the ability to dynamically transcode a particular source document in several different ways for use by multiple different receivers avoids a potentially large storage requirement and the need to provide a library management facility to track all the resulting document variants. Thus, automatic transcoding has the potential to reduce significant content maintenance overheads that would otherwise be incurred by content providers attempting to support pervasive computing devices. Unfortunately, automatic transcoding techniques are not a panacea. When automatic transcoding techniques are demonstrated to customers who may be interested in purchasing a transcoding solution, in many cases the customers generally like the results they see, but a number of problem areas remain. Examples of these problem areas include the following:

1) In many cases, when a customer sees a page rendered on a pervasive device and then proceeds to use the navigational techniques available on that device, the customer concludes that too much content is being sent to the device. It would be preferable to permit only a subset of page content to be transcoded, by reducing or “clipping” the content of the source HTML page or document. (Hereinafter, references to “HTML page” or “HTML document” are intended to refer equivalently to structured documents created in other markup languages as well, unless otherwise noted or unless the topic under discussion has no counterpart in other markup languages.) By clipping the content, only a small subset of the content would be transcoded and sent to the requesting client.

2) In some cases, the techniques for automatically transcoding an HTML form lead to results. For example, labels that are beneath the text field they reference cannot be viewed easily when automatically transcoded to HDML, which has no native forms element. It would be preferable to see forms and other HTML elements which do not translate well into other markup languages transcoded more appropriately for particular target devices.

3) Replacing some HTML elements or attributes with substitutes more appropriate for a target device would be preferable. For example, in some situations, customers desire to replace image elements with text elements because images do not render well on some pervasive devices.

4) Dynamically applying transcoding preferences to only selected portions of an HTML page would be beneficial in some cases. WebSphere Transcoding Publisher has configurable options for issues such as the best way to transcode a table, for example by converting the table rows and columns into a list. In some cases, it is desirable to be able to dynamically select the transcoding approach for each table individually.

5) In many cases, there are fine differences in the way an HTML page should be transcoded for different target devices that share the same output markup language. For example, some WAP-enabled phones show tables effectively, while others do not. It is desirable to have a way to specify different ways to transcode certain sections of HTML, where the correct way is selected at run time based on the characteristics of the specific target device.

6) In some cases, the results of transcoding can be substantially improved by inserting blocks of HTML. For example, the results of “clipping” as described in (1) above can often be made more attractive by inserting breaks (e.g. <BR/> tags) to create white space between retained elements. For another example, many HTML pages on the Internet are badly formed in ways that produce unattractive results when transcoded to other markup languages. It is possible and desirable to repair the source document by inserting additional HTML tags.

7) In some cases, the most effective way to transcode an HTML element is to replace it with a block of information in the target markup language. For example, the Javascript entities in one or more HTML pages could be replaced with corresponding WML Script entities if the target language is WML.

These problem areas are merely representative. Other areas may exist where automated transcoding is an advantageous technique for content delivery, but where there is still room for improving the transcoding process. A solution to these transcoding problems must be provided in a generic, reusable manner that does not require the customer to individually modify each existing Web page or each page-generating application. The solution must be adaptable not only to statically-generated content, but to dynamically-generated content as well.

### SUMMARY OF THE INVENTION

An object of the present invention is to provide techniques for enhancing the automated transcoding process.

Another object of the present invention is to enhance automated transcoding through use of annotations.

Yet another object of the present invention is to provide techniques for annotating Web content that can be used with dynamically-generated as well as with statically-generated content.

A further object of the present invention is to provide techniques for annotating Web content that can optionally be used with entire page families.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for enhanced transcoding of structured documents through use of annotations. In one aspect, this technique comprises: specifying one or more annotations and inserting one or more selected ones of the specified annotations in an a particular document, thereby preparing the particular document for enhanced transcoding. The inclusion may occur programmatically. This aspect may further comprise transcoding the particular document using the inserted annotations.

The specified annotations may be specified separately from the particular document and or may be specified within the particular document. The specified annotations may request one or more of: clipping content from a document; changes to one or more form elements in a document; one or more nodes to be replaced in a document; one or more (attribute name, attribute value) pairs to be inserted into a document; fine-grained transcoding preferences to be inserted into a document; conditional syntax stating when the annotation(s) is/are to be inserted into a document; Hypertext Markup Language (“HTML”) syntax to be inserted into a document; and rendered markup language syntax to be inserted into a document. The fine-grained transcoding preferences may pertain, for example, to a table in the document. In this case, the annotation may optionally specify one or more rows and/or columns to be clipped from the table. If clipping is requested in an annotation, the annotation may optionally specify one or more clipping exceptions.

A location where each of the selected annotations is to be inserted is preferably specified as an attribute of that annotation. In this case, the location may be expressed using positional information that is based upon target tags in a target document. XPath notation is preferably used for expressing the location. Preferably, the positional information enables case-insensitive matching of text in the target document. The text to be matched may appear, for example, as a tag or as an attribute value in the target document. The positional information preferably enables the insertion of the selected one(s) to operate with statically-generated document content as well as with dynamically-generated document content. document.

A definition of the annotation preferably indicates whether the annotation should be inserted before or after the location. The definition of a particular one of the specified annotations may state one or more (key, value) pairs that indicate when this particular annotation is applicable. An annotation file in which at least one of the specified annotations is stored may have an associated (key, value) pair that indicates when this annotation file is applicable.

In another aspect, the technique of the present invention comprises: receiving a request for a structured document; locating one or more annotation files which contain annotations which are pertinent to the request; and inserting the pertinent annotations into the structured document, thereby creating an annotated document. This technique may further comprise applying the annotations in the annotated document, thereby creating a modified document, and transcoding the modified document, thereby creating a transcoded document. In addition, the technique may comprise sending the transcoded document to a device which issued the request.

In yet another aspect, the technique of the present invention comprises: receiving a request for a structured document; locating one or more annotation files which contain annotations which are pertinent to the request; applying the pertinent annotations to the structured document, thereby creating a modified document; and transcoding the modified document, thereby creating a transcoded document.

The present invention will now be described with reference to the following drawings, in which like reference numbers denote the same element throughout.

### BRIEF DESCRIPTION OF THE DRAWINGS

FIGS. 1A and 1B illustrate an overall flow of a sample source document as it is processed by an annotation engine according to the present invention, transcoded, and sent to a requesting target device;

FIG. 2A illustrates a sample internal annotation that may be used for enhanced transcoding, according to preferred embodiments of the present invention;

FIG. 2B depicts a result of applying the internal annotation of FIG. 2A;

FIG. 3 illustrates a transformation that may be performed on search operators, according to the prior art;

FIG. 4A depicts a fragment of a structured document, and FIG. 4B shows syntax that may be used according to the present invention to pinpoint a location within that structured document;

FIG. 5A illustrates a sample external annotation that may be used for enhanced transcoding, according to preferred embodiments of the present invention;

FIG. 5B depicts a sample HTML page into which the external annotation of FIG. 5A may be embedded;

FIG.6 provides a sample external annotation file in which an optional characteristics marking feature described herein is illustrated;

FIGS. 7A-7C depict use of annotation for clipping content from source documents prior to transcoding and delivery to a requester;

FIG. 8 is used to describe the hint state stack which may be used with implementations of the present invention;

FIGS. 9A-9C depict use of annotations which provide improved transcoding of HTML forms;

FIG. 10 is used to describe annotations which may be used to replace nodes and/or attributes in a source document;

FIGS. 11A-11C depict use of an annotation feature which provides fine-grained control over transcoding, wherein elements of complex structures such as tables may be selectively clipped or otherwise processed;

FIGS. 12A-12C provide an example showing how a table may be altered when the table annotation feature is used to influence transcoding;

FIGS.13A-13C illustrate how conditional annotation information may be specified, according to preferred embodiments of the present invention;

FIGS. 14 and 15 illustrate annotations which may be used to insert markup into a document;

FIGS. 16-23 provide flowcharts depicting logic which may be used in implementing preferred embodiments of the present invention; and

Appendix A contains a document which discusses the annotation technique used in IBM's WebSphere® Transcoding Publisher, including a Document Type Definition (“DTD”) of an annotation grammar and examples of annotations, based upon the techniques of the present invention. (“WebSphere” is a registered trademark of IBM.)

### DESCRIPTION OF PREFERRED EMBODIMENTS

In preferred embodiments, the present invention is implemented in software. Software programming code which embodies the present invention may be embodied on any of a variety of known media for use with a computing device, such as a diskette, hard drive, or CD-ROM. The code may be distributed on such media, or may be distributed from the memory or storage of one computing device over a network of some type to one or more other computing devices for use by such other devices. Alternatively, the programming code may be embodied in the memory of a computing device on which the present invention operates. The techniques and methods for embodying software programming code in memory, on physical media, and/or distributing software code via networks are well known and will not be further discussed herein.

The present invention may be used in a networking environment wherein an HTML document is requested by a client from a server, and annotation is applied to the requested document, which is then transcoded prior to delivery to the requester over the network. Alternatively, the present invention may be used in a stand-alone mode without having a network connection, such as by a content developer who wishes to create annotated content in order to prepare it for subsequent application and transcoding on a particular machine (or machines). The present invention may also be used in a stand-alone environment when a developer creates and applies annotations for content and then transcodes that content for subsequent delivery to an end-user device from a locally-available media such as a CD-ROM or diskette, rather than across a network connection. When used in a networking environment, wireline or wireless connections may be used. Wireline connections are those that use physical media such as cables and telephone lines, whereas wireless connections use media such as satellite links, radio frequency waves, and infrared waves. Many connection techniques can be used with these various media, such as: using the device's modem to establish a connection over a telephone line; using a LAN card such as Token Ring or Ethernet; using a cellular modem to establish a wireless connection; etc. The client device may be any type of computer processor, including laptop, handheld or mobile computers; vehicle-mounted devices; “smart” appliances in the home; Web-enabled cellular phones; personal digital assistants or “DAs”; desktop computers; mainframe computers; etc., having processing capabilities (and communication capabilities, when the device is network-connected). The server, similarly, can be one of any number of different types of computer which have processing and communication capabilities. These techniques are well known in the art, and the hardware devices and software which enable their use are readily available. Hereinafter, the client computer will be referred to equivalently as an “end-user device”, “device”, or “computer”, and use of any of these terms or the term “server” refers to any of the types of computing devices described above.

An implementation of the present invention may be executing in a Web environment, where structured documents are delivered using a protocol such as the HyperText Transfer Protocol (“HTTP”) from a server to target devices which are connected through the Internet. Alternatively, an implementation of the present invention may be executing in other non-Web networking environments (using the Internet, a corporate intranet or extranet, or any other type of network). Configurations for the environment include a client/server network, as well as a multi-tier environment. Or, as stated above, the present invention may be used in a stand-alone environment. These environments and configurations are well known in the art.

The present invention defines techniques for annotating HTML that enable a transcoder to provide better customization and refinements of rendered output than what is available with existing approaches for automatic transcoding. Furthermore, the disclosed techniques allow annotations to be provided in-line within HTML documents, as well as externally, in a way that allows them to be used with both statically-generated and dynamically-generated pages and even applied to page families based on content patterns. (The term “page families” is used herein to refer to multiple pages which share some common feature. For example, a page family may comprise a group of pages which contain tables. As another example, a page family may comprise all the pages at a particular site which contain HTML anchor tags, which may be important if an annotation is written to remove the anchor tags from all documents. An optional technique for marking annotations in order to selectively associate them with page families according to explicitly-specified characteristics is described below.)

In preferred embodiments, the annotation techniques disclosed herein support features which are directed toward solving automated transcoding problems such as those previously discussed. A particular implementation of the present invention may support all of these annotation features, only one of the annotation features, or some combination thereof. These annotation features will be referred to herein as (1) clipping, (2) enhanced form support, (3) node and/or attribute replacement, (4) fine-grained transcoding preference support; (5) conditional annotation; (6) insert HTML; and (7) insert rendered markup. Each of these annotation features will be described in detail herein. Furthermore, it should be noted that additional or different features may be provided in an implementation of the present invention based upon the teachings disclosed herein, and that such extensions are within the scope of the present invention.

The techniques of the present invention apply annotations to a structured document before the document is transcoded. As used herein, the term “annotation” refers to a hint or processing instruction that provides extra information regarding how to preprocess an HTML page such that the result of this preprocessing is a modified version of the page that is better suited for transcoding than the original page itself The term “annotation file” refers to a stored collection of one or more annotations.

Once a document has been annotated and the annotations have been applied, the modified document may be used as input to more than one type of transcoding operation. For example, a particular modified page may be transcoded once for optimally delivering content to a PDA, but transcoded differently when the target device is a cell phone, and yet another transcoding may be performed if the target device is a laptop computer.

The annotations used by the present invention come in two forms, namely (1) internal annotations and (2) external annotations. Internal annotations are embedded directly into the HTML page itself. According to preferred embodiments of the present invention, the embedded annotation syntax for internal annotations is represented using a comment when inserted into HTML markup. (When inserting annotations into other markup languages, comments may also be used, if desired. Or, when inserted into an extensible notation such as XML, specially-defined annotation delimiting tags such as “<annot>” may be sufficient to bracket the annotation syntax. Optionally, such tags may include a specialized XML namespace prefix.) The embedding of internal annotations may be performed manually, but is preferably performed through use of an automated editing tool such as a content developer's toolkit. (An example of such a toolkit is the Page Designer component of the IBM WebSphere Studio product.) An external annotation is defined in an external annotation file (which is referred to herein equivalently as simply an annotation file). When processed by an annotation engine implemented according to the present invention, these external annotations will be converted into internal annotations by programmatically inserting them into a document.

An annotation engine according to the present invention generally operates to perform two different functions: it merges external annotations in with a source document or a copy thereof (where this source document or copy may already include one or more internal annotations) and it applies annotations to modify a document. (Alternatively, external annotations could be processed directly to create a modified document, without actually inserting the annotations into the source document or copy.)

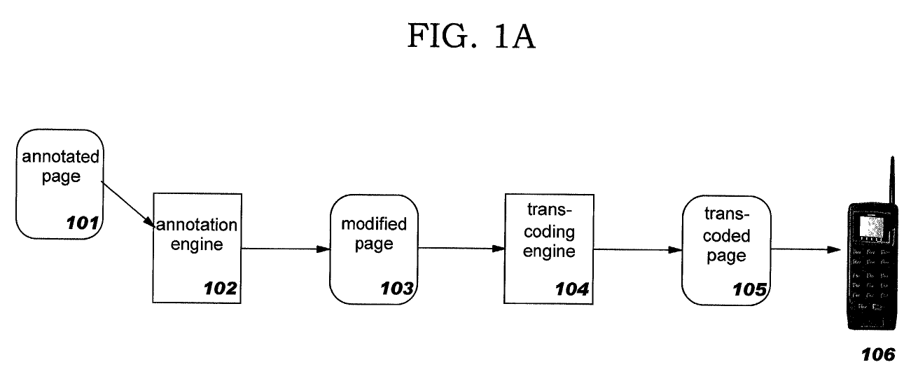

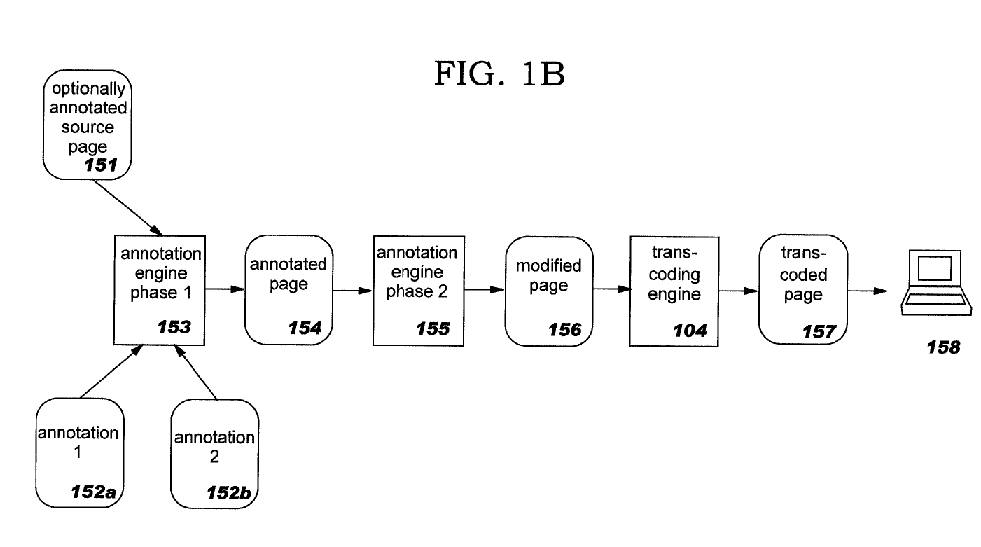

FIG. 1A shows the flow of a source document 101 which contains internal (i.e. embedded) annotations, and FIG. 1B shows the flow of a source document 151 (which optionally may contain internal annotations) into which one or more annotations from one or more annotation files are embedded. (Note that the flow in FIG. 1B applies both to documents which contain internal annotations and to those which do not.) Referring first to FIG. 1A, an input HTML page 101 containing one or more internal annotations is provided to an annotation engine 102, which generates a modified page 103 from this annotated page 101. (For example, if clipping annotations of the type described below are embedded in page 101, then an annotation engine created according to preferred embodiments of the present invention clips out content to create page 103.) Page 103 is then processed by a transcoding engine 104, creating a transcoded page 105. This transcoded page may then be delivered to a client 106. Optionally, the modified page 103 and/or the transcoded page 105 may be cached or otherwise stored. For example, modified page 103 may be stored (at least temporarily) for use as input to other transcoding operations, and transcoded page 105 may be stored for delivery to other appropriate client devices.

In the flow shown in FIG. 1B, an optionally-annotated input HTML page 151 and one or more annotation files 152a, 152b are provided to annotation engine 153 to generate an annotated page 154. Annotation engine 153 is labeled “phase 1” in FIG. 1B to reflect that this step comprises the merging of annotations into a source document, thereby generating the annotated page, whereas annotation engine 155 is labeled “phase 2” to reflect the application of the annotations, thereby generating a modified page 156. (Note that this separation of the annotation engine into two phases in FIG. 1B is not meant to imply the existence of two physically-separate components: both phases may be implemented within the same software image. Furthermore, when processing external annotations directly, as in the alternative approach mentioned above, the processing shown at 153, 154, and 155 of FIG. 1B may be compressed such that page 156 is generated directly from page 151 and the annotation files 152a, 152b.) This modified page 156 is subsequently used as input to transcoding engine 104, creating transcoded page 157. This transcoded page may then be delivered to client 158, and may optionally be cached or stored as described with reference to FIG. 1A.

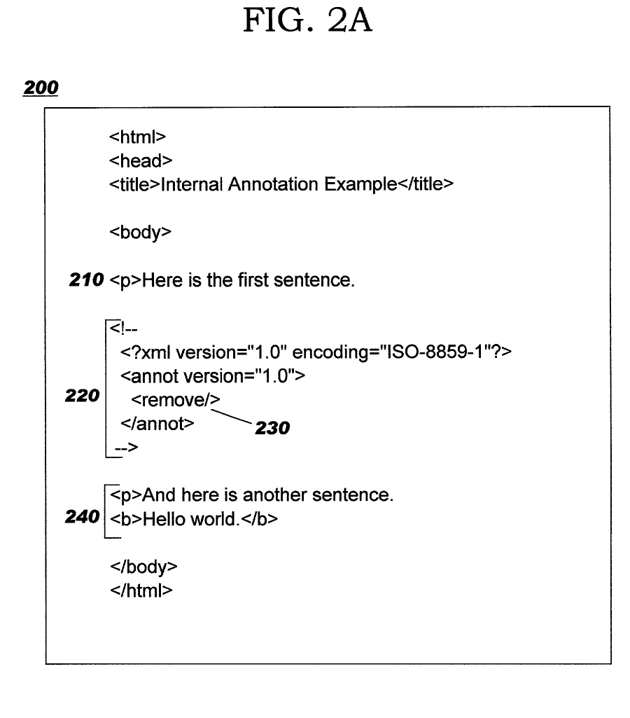

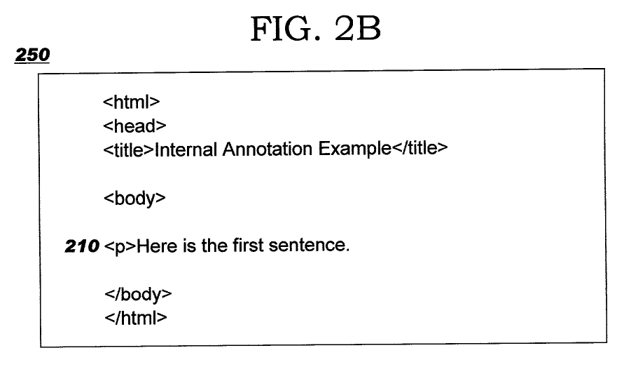

A simple example of an internal annotation 220 embedded within an HTML page 200 is provided in FIG. 2A. This annotation is used to remove or “clip” portions of the HTML page, as indicated by the “<remove/>” tag 230, and begins to take effect at the point in the HTML document where this comment is located. Thus, an annotation engine operating according to the present invention will create the revised document 250 shown in FIG. 2B after processing the internal annotation in FIG. 2A. By comparing the two documents, it can be seen that the text 210 of the input document which appears prior to the “remove” annotation 220 remains intact, while the text 240 following the annotation has been clipped out. (This revised document 250 may be further modified during transcoding. For example, formatting may be applied to the text element 210, perhaps to increase the font size. As will be obvious, many types of transcoding operations may be performed after processing annotations for documents which are more complex than the simple example illustrated by FIGS. 2A and 2B.)

Note that the annotation 220 shown in FIG. 2A uses HTML comment syntax, as previously stated, and also includes an “<?xml . . . ?>” tag to provide information about the XML syntax that is being embedded. The tag “<annot version=“1.0”>” is used in preferred embodiments to bracket the annotation description(s) included between this opening tag and its corresponding closing tag and to indicate that this is version 1.0 (in this example) of the annotation syntax. (Note that tags such as this “annot” tag and the other annotation tags discussed herein may come from a specialized XML namespace, as stated earlier.) A DTD providing an annotation grammar that may be used with an implementation of the present invention is included in the attached Appendix A, which is titled “Using Annotators” and which is incorporated herein by reference. Note that this is merely one example of an annotation grammar that may be used to support the inventive features of the present invention. As will be obvious to one of skill in the art, additional or different tags may be used, and additional or different annotation features may be supported, without deviating from the scope of the present invention.

In preferred embodiments, a “description” tag is used to define each annotation in an annotation file, and this description tag includes a “target” attribute which identifies what part of a target structured document each annotation applies to. Optionally, the description tag may include other attributes such as a “take-effect” attribute and/or a “match-key” attribute.

The value of the target attribute is preferably specified using XPath notation. XPath is defined in a specification titled “XML Path Language (XPath), Version 1.0”, W3C Recommendation 16 November 1999, which is available on the Internet at http://www.w3.org/TR/xpath. As is known in the art, XPath constructs may be used to address parts of a markup language document. The value of an XPath construct may be used to identify a node or a collection of nodes in the Document Object Model (“DOM”) tree which is created by a markup language parser to represent a particular markup language document. The XPath specification defines, among other things, a core library of functions which every XPath implementation must support in order to evaluate expressions in the XPath notation. Implementations of XPath may add additional functions to this core library. For purposes of the present invention, the core library is preferably extended by the addition of a string function which is referred to herein as “globb-match”. The term “globbing” has been used in the prior art to refer to searching for strings that match a pattern which is specified using a specially-defined argument string syntax. The pattern is often referred to as a “globbing pattern”, meaning a human user-friendly way of specifying how to recognize a string as belonging to the search result set. Globbing patterns are used in the prior art for specifying file names to be matched in a File Transfer Protocol, or “FTP”, search, for example.

The globb-match function of the present invention is designed to return a Boolean representing the result of a case-insensitive matching of its first argument string by a “globbing” pattern provided as its second argument string. This globb-match function follows the same implementation pattern as the XPath core library's “contains” string function. The globb-match function provides several advantages over the contains function, however, and allows for more flexible and more powerful searching. One advantage of the globb-match function over the contains function of the core library is that the contains function is designed to provide case-sensitive matching. The globb-match function, on the other hand, is designed to be case-insensitive, making it a much more user-friendly matching operator. The examples and descriptions herein assume that both the markup documents (e.g. the source HTML page being annotated) and the external annotations are encoded with Unicode character representation. Therefore, the term “case-insensitive” as used herein means that operations occur under a mapping of characters as described by the “Unicode Technical Report #21 Case Mappings” document which can be found on the Internet at http://www.unicode.org/unicodelreports/tr21/.

A second advantage of the globb-match function defined herein is that globb-match supports a set of globbing operators in a globbing pattern which appears as the function's second argument. The globbing operators make searches that use globb-match more powerful than those which are available with the simpler contains function.

In preferred embodiments, globbing patterns use a syntax which is adapted from that supported by the Unix® operating system shell. (“Unix” is a registered trademark of X/Open Company Limited.) Within the pattern string, six characters take on special meaning which drives the action of the implementing matching engine as follows:

1) “*” The asterisk matches zero or more characters.

2) “?” The question mark matches one character.

3) “{” The left brace marks the start of a “multiple choices” region.

4) “}” The right brace marks the end of a “multiple choices” region.

5) “,” The comma separates alternate elements in a “multiple choices” region.

6) “\” The backslash is used to quote the next character, causing it to be interpreted literally, and not as a meta-character. (For example, the syntax “?\*” says to match an asterisk character which is preceded by a single character of any value. This pattern would match strings such as “A*”, “B*”, . . . “Z*B” or “1*”, but would not match strings such as “AA”, “*”, “AA*”, or “A*A”.)

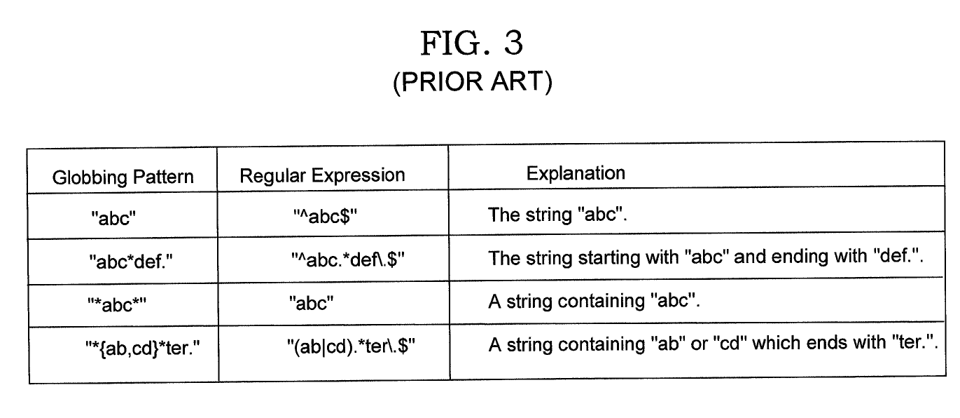

Algorithms exist which allow a globbing pattern to be transformed into a “regular expression”, which is a machine-friendly pattern notation used by many search engines. Some examples of these pattern transformations are shown in FIG. 3. (The description of the six special characters and the example patterns in FIG. 3 are adapted from a Web page which is titled “Globbing in FTP search”, copyright 1998 by John Engstrom, and which may be found on the Internet at location http://www.bahnhof.se/˜engstrom/e_globbing.htm.)

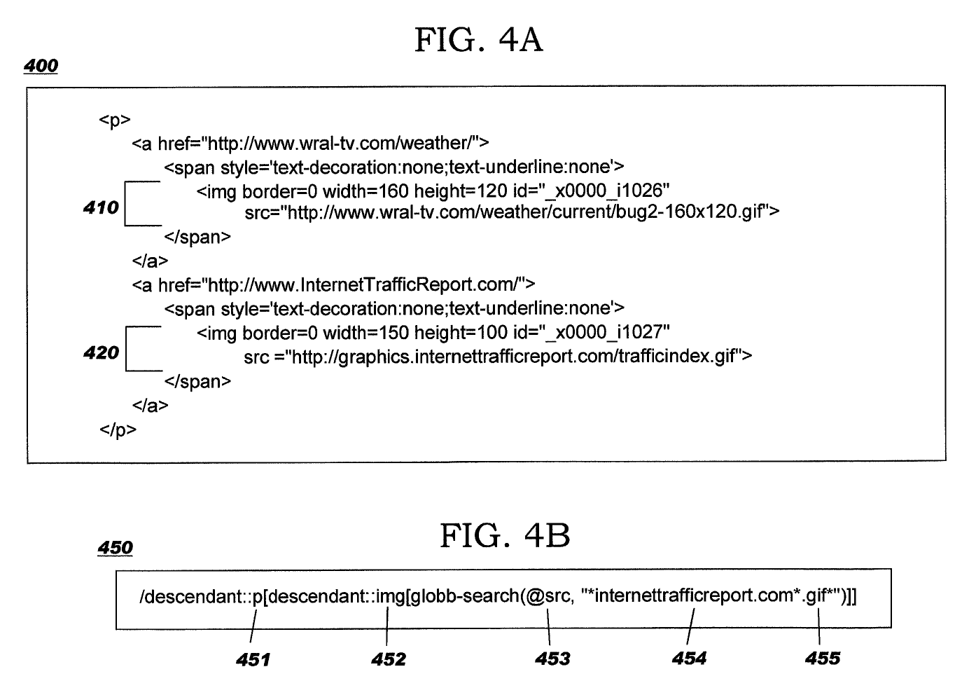

Putting this all together, this means that if one wanted to identify paragraphs in an HTML document which contained a GIF image from a Web site named “internettrafficreport.com”, such as the example HTML page 400 shown in FIG. 4A, one could use the XPath specification 450 shown in FIG. 4B. The XPath specification 450 indicates a search for an image tag (denoted by the “img” parameter at 452) which is a descendant of a paragraph tag (denoted by the “p” parameter at 451), where the attribute value of the image tag contains the string “internettrafficreport.com” (see 454) followed by the string “.gif” (see 455). The syntax “@src” shown at 453 is used in the globb-match function defined herein to indicate that the pattern being searched for is a value of the “src” attribute; when the “@” is omitted from the first parameter, this indicates that the pattern being searched for is a tag name. rather than an attribute value This specification 450 therefore matches the paragraph depicted by FIG. 4A because the globb-search sub-expression evaluates to “TRUE” when evaluating the image element 420 in FIG. 4A. (Note that this sub-expression evaluates to ‘FALSE’ for the image element 410.)

Note that support for the globb-match function is an optional aspect of the present invention. While this function provides a number of advantages, as previously discussed, simple searches may alternatively be provided through use of the existing XPath contains function, without deviating from the scope of the present invention. The globb-match function enables very powerful search patterns to be constructed quite easily. Constructing equivalent search patterns using the XPath contains function, however, may be quite difficult and in some cases may be impossible. (For example, constructing a search pattern to perform a case-insensitive match of a string of length “N” alphabetic characters using XPath contains would require creating 2^{N} distinct search patterns and somehow OR'ing their results, whereas the case-insensitive globb-match function requires only one search pattern.)

Returning to the description tag, the take-effect attribute preferably has two allowable values, which are referred to herein as “before” and “after”. The values of this attribute indicate whether the defined annotation should take effect before the location specified by the target attribute, or after it. Alternatively, a separate take-effect-before and/or take-effect-after tag may be used (in which case the take-effect attribute should be omitted). A default value may be defined for the take-effect attribute, if desired. Combining the XPath information and the value of the take-effect attribute/tag enables pinpointing the specific location(s) in the HTML document to embed the external annotation. According to the present invention, the annotation will be placed as a sibling before or after the node(s) denoted by the XPath value on the target attribute, depending on the value of the take-effect attribute or tag. Note that when placing an annotation as a new sibling after a node, in terms of the HTML document this requires placing the annotation after all the node's descendants, when descendants exist. (In general, specifying the take-effect value using a stand-alone take-effect tag is equivalent to using a take-effect attribute on the description tag. However, using the stand-alone take-effect tag syntax, which is also referred to herein as a “take-effect clause”, has the advantage of allowing annotations to be specified both before and after each node of the collection identified by the XPath syntax on the target attribute.)

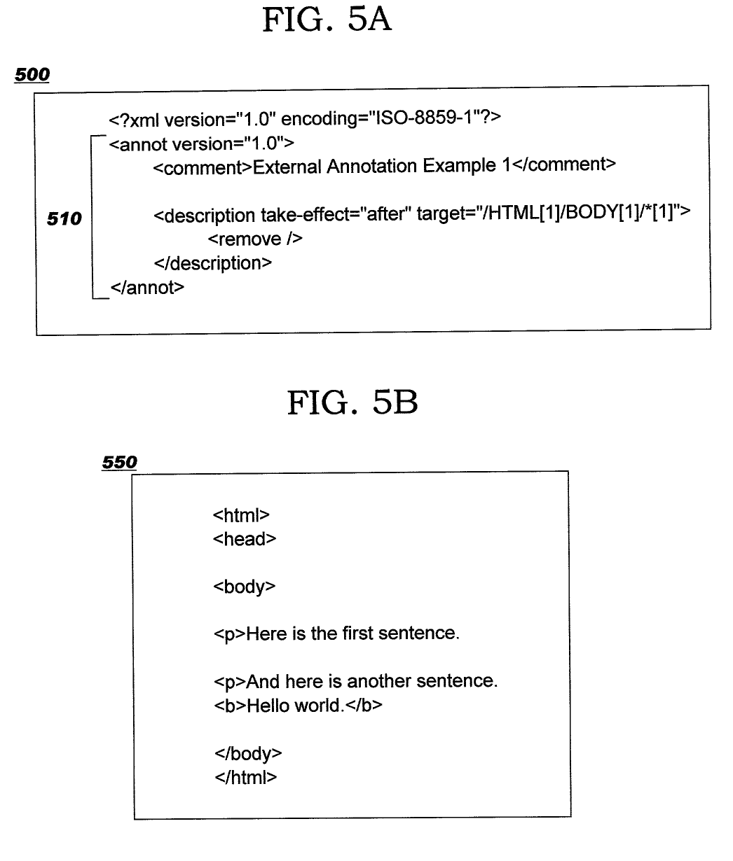

Referring now to FIG. 5A, a simple example of an external annotation file 500 containing a single annotation 510 is provided. The description of this annotation 510 specifies that it is to take effect after the first child of the first BODY tag following the first HTML tag. When applied to the HTML page 550 shown in FIG. 5B, the annotation 510 in this example yields the internal annotation example 200 and its embedded annotation 220 as shown in FIG. 2A (except, of course, for the differences in the <title> and <comment> tags in FIGS. 2A and 5A, respectively).

The match-key attribute of the description tag enables the annotation writer to define annotations that are to be applied to documents only when certain conditions are met. As will be obvious to one of skill in the art, the annotations that are desirable from one implementation of the present invention to another may vary widely based upon factors which include the characteristics of target documents, the characteristics of the receiving device and/or its software, and so forth. Support for the match-key attribute is an optional enhancement of the present invention which enables marking annotations in annotation files with target characteristics which may be used to dynamically and programmatically select, at run time, the annotation(s) which are applicable for a particular situation (such as selecting one or more annotations which are marked as being applicable to a particular target device, or to a particular type of user agent, and so forth). As examples of using match-key attributes, one external annotation file may define annotations that may be applied to any structured document containing image files, while another external annotation file may contain annotations that are only useful to a structured document which contains a particular sequence of tags. In addition, a single annotation file created according to the present invention may contain multiple annotations which are to be used selectively (e.g. as alternatives). As an example of this latter situation, an annotation file may be created which contains annotations designed to enhance the transcoding of images based upon characteristics of the target device: if the device has a full-color display, then one annotation may be appropriate whereas a different annotation may be appropriate otherwise. As another example, one annotation may be selected from an annotation file if the document was requested from one type of user agent, whereas this annotation might be omitted otherwise. (Information regarding the type of user agent, requesting device, and so forth may be determined by inspecting the HTTP header of the document request, using prior art techniques.)

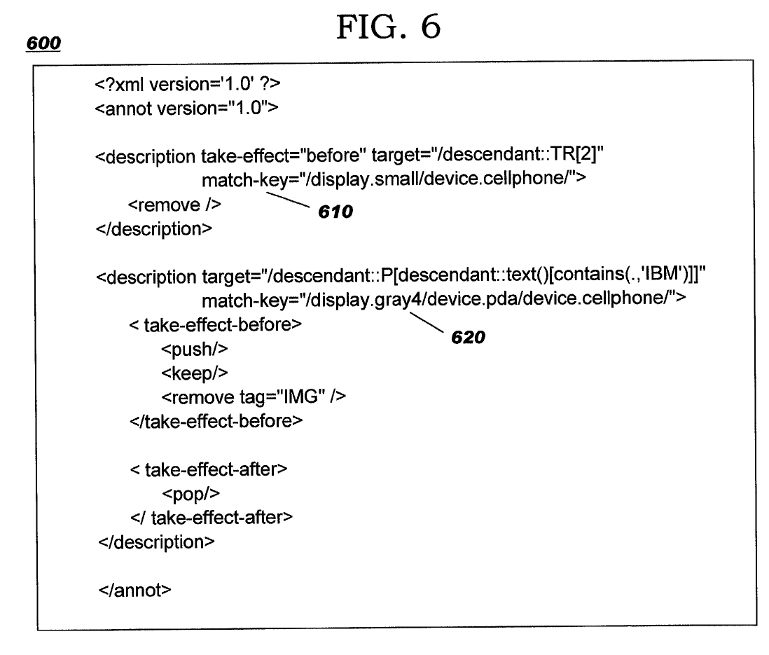

Use of this match-key attribute to mark annotations optimizes the process of defining annotations and of applying external annotations to source documents. Preferably, this marking technique is adapted from the approach disclosed for marking style sheets in U.S. Pat. No. ______ (Ser. No. 09/287,988, filed Mar. 8, 1999), which is titled “Retrieval of Style Sheets from Directories Based Upon Partial Characteristic Matching” and which is hereby incorporated herein by reference. This U.S. patent teaches a technique whereby information about the applicability of style sheets to particular uses (i.e. the characteristics of the style sheet) may be specified as name/value pairs that are stored and used by a search engine to locate style sheets that may be appropriate for use in a particular situations. When used with the external annotations of the present invention, the specified characteristics describe the applicability of the annotations for particular uses. For example, the characteristics may describe the target device(s) to which the annotation is applicable, or the target browser(s) or user agent(s) for which the annotation is adapted, etc. The annotation engine may then efficiently select properly-characterized annotations from among those which are available. (Or, a separate search engine may perform this selection on behalf of the annotation engine.) FIG. 6 illustrates a syntax which may be used for this purpose, wherein a match-key or similar attribute specifies the desired characteristic values, as shown at 610 and 620. (Alternatively, a separate match-key tag might be used for this purpose.) In preferred embodiments, the match-key value contains one or more key-value pairs which are to be compared at run time against values of one or more externally-supplied parameters to determine if the parameters match the key-value pairs. Following the syntax defined in the referenced U.S. patent, a “/” is used to delimit one key-value pair from another, and the key and its value are delimited by a “.”. Multiple key-value pair specifications are preferably interpreted using “OR” semantics. When a single key-value pair is used, it is preferably encoded using the syntax “/key.value”.

As stated above, depending on the characteristics of the target devices/browsers and the characteristic values coded on the match-key attribute, the annotations which contain a match-key attribute are conditionally applied. For example, the remove tag is only embedded into a source document according to annotation 610 if the target device has a small display or if it is a cell phone (assuming that the specified characteristics are OR'd together when comparing them to the target device's characteristics). On the other hand, the annotation 620 is only applied to a source document if the target device's display has the characteristic “gray4” (which may signify, for example, that it supports a certain type of grayscale), if it is a PDA, or if it is a cell phone. Using this match-key approach allows a single external annotation file to contain annotations that may be used to annotate documents for multiple targets with a minimum of repetition and, when the techniques of this U.S. patent are used for style sheets, provides site authoring consistency between annotation and styling. When characteristics are used in conjunction with content value patterns in XPath specifications, a single external annotation file can be used to optimally tailor entire page families for use on multiple target devices and/or by multiple target browsers and so forth. Note that characteristics of target devices and target browsers are merely two examples of use of the match-key function of the present invention. Additional factors, such as an identification of the target end-user, the type of network connection in use, and so forth, may also be represented and used to selectively apply annotations in this manner.

While the match-key attribute adopts the syntax of the referenced U.S. patent for specifying key-value pairs within an annotation file, the external file characteristic marking technique defined therein may be also be used to externally mark an annotation file. That is, one or more key-value pairs may be associated with a particular annotation file to indicate, at a high level, the target documents to which this annotation file might apply. Suppose, for example, that a set of annotations pertaining to particular types of PDAs are defined, and further suppose that these annotations are of no use with any other type of non-PDA device. A key-value pair such as “/device.pda” might then be associated with the name or other identifier of the annotation file, and this association may be stored in a directory or otherwise made available for processing by a lookup operation. Upon determining that the requesting device is a PDA, this example annotation file would be evaluated to determine whether any of its stored annotations should be applied to the requested document; if the requesting device is not a PDA, then the annotation file does not need to be considered further. Continuing with this example, the annotations in the annotation file might be defined such that they conditionally apply to specific types of PDA devices by including match-key attributes on the description tags. In this manner, a two-level hierarchy of conditional evaluations may be supported. (Techniques for processing this type of external characteristic with a directory query engine or other lookup technique are discussed in detail in the referenced U.S. patent, and may be used in an analogous manner for processing external characteristic markings of annotation files. Note also that this external marking technique may be used without requiring support for the internal match-key attribute.)

The previously-mentioned annotation features which may be supported by an implementation of the present invention will now be described in more detail.

The first such feature, clipping, may be used to reduce the amount of content in the source document (that is, in a temporary copy thereof which is created for use with the present invention) so that only the desired portions of the HTML remain to be transcoded for the target device. The clipping model used in preferred embodiments is a state-based model that has two primary states, keep and remove. When in the remove state, content is removed. When in the keep state, content is kept. In addition, individual tag types may be declared as exceptions. For example, one could declare the primary state to be remove but then list “IMG” (i.e. image tags) as an exception. In this scenario, all content except images would be removed. The clipping model permits individual nodes, subtrees, and collections of subtrees from the original HTML DOM to be clipped.

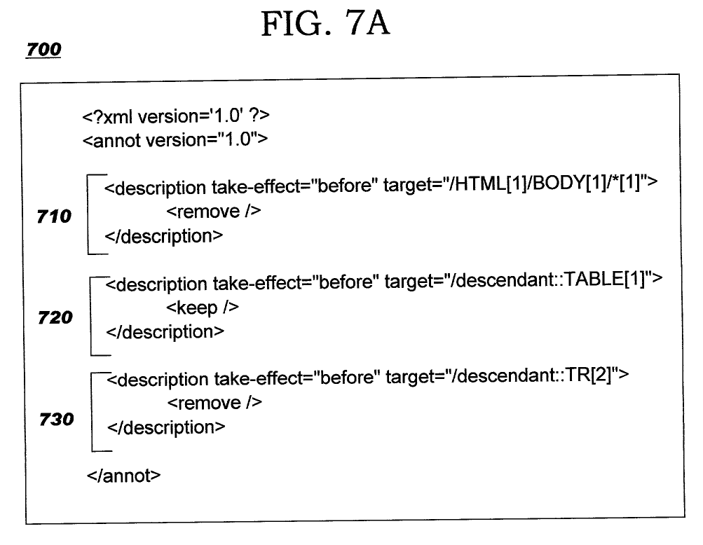

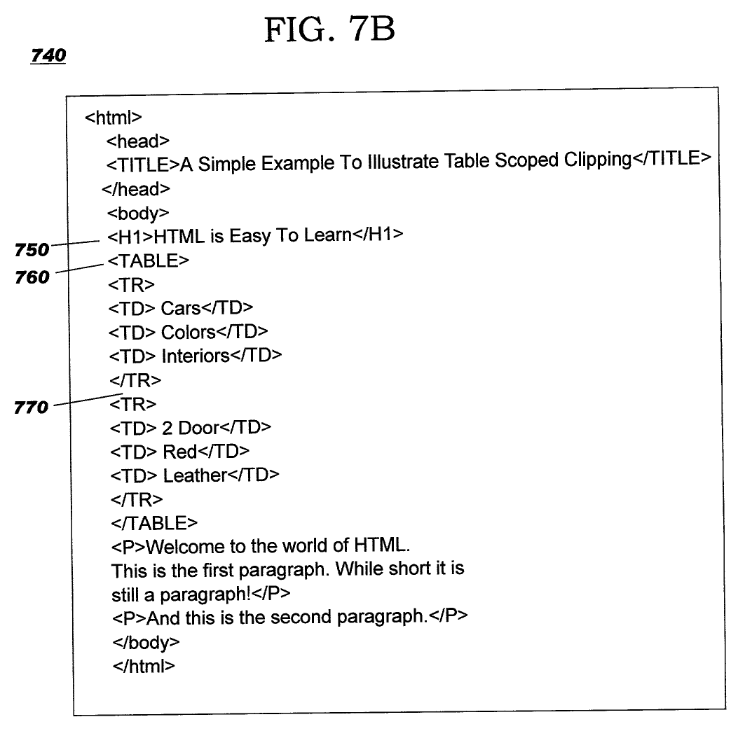

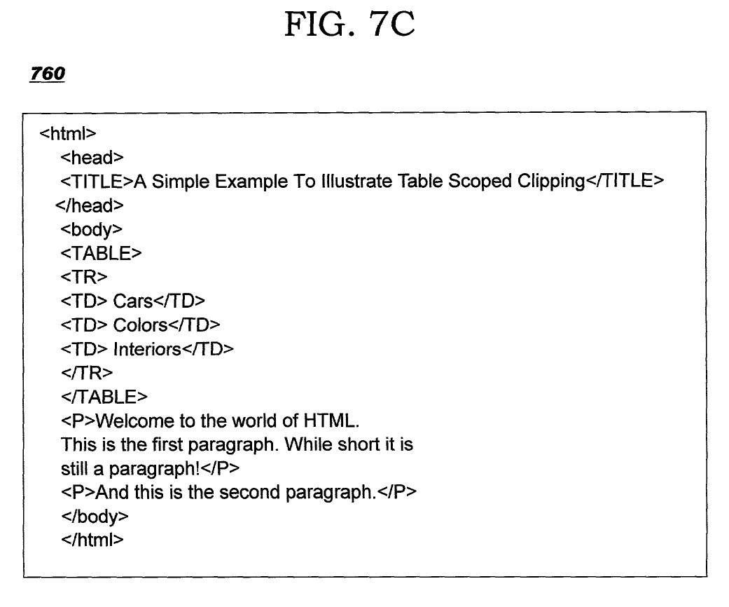

Examples of using the remove clipping state have been previously discussed with reference to FIGS. 2A, 2B, 5A, and 5B, and it will be obvious from these examples how the keep state operates. FIG. 7A provides a more complicated example of an external annotation file 700 which contains clipping annotations, wherein the clipping state is explicitly changed when specific tag sequences are encountered in a source document. The source document 740 in FIG. 7B may be annotated using the annotations 710, 720, 730 in this external annotation file. When the annotations are then processed, the document 760 shown in FIG. 7C results. By inspection of these example files, it can be seen that the first annotation 710 is to be inserted into the source file (or, equivalently, into a DOM representing the source file) before the first child of the first body tag after the first HTML tag. Thus, the remove tag from the annotation will be placed before the <H1> tag 750. The second annotation 720 is to be inserted before the first table tag, and thus the keep tag will be placed after the <H1> tag 750 and before the following <TABLE> tag 760. This has the effect, for this input document 740, of clipping out only the <H1> tag and its content. Finally, the third annotation 730 indicates that a remove tag should be inserted before the second table row (“TR”) tag (i.e. at the location indicated by 770). Note that each inserted annotation becomes a sibling of the node it was inserted in reference to in the DOM representing the annotated document. For example, the remove tag from annotation 710 becomes a prior sibling of the <H1> tag, and the keep tag from annotation 720 then becomes this <H1> tag's following sibling.

Text clippers are known in the art which use a programming language such as the Java™ programming language. (“Java” is a trademark of Sun Microsystems, Inc.) However, use of such clippers is sometimes undesirable, as it requires knowledge of the programming language. The technique of the present invention uses a syntax which is based upon the XML notation and is therefore more user-friendly and does not require programming skills. (Tools may be developed to provide a higher abstraction of the syntax described herein, such as by providing a graphical user interface where the user is prompted to enter information required for programmatically generating the underlying markup language tags, if desired.)

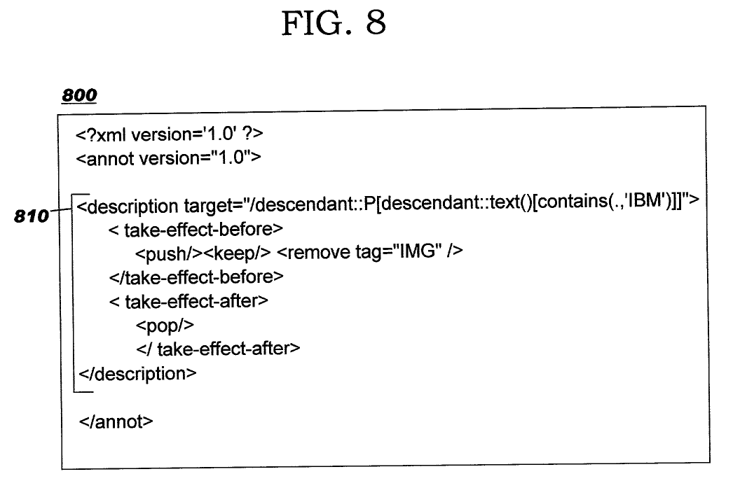

In preferred embodiments of the present invention, a clipping state stack may be used which allows inline annotations to be augmented by page family external annotation definitions. The <push/> element of the annotation grammar indicates that the current annotation states should be placed on the state stack while the <pop/> element indicates that the annotation states should be set to the values on top of the stack which are then removed from the stack. An example of an external annotation definition 810 which causes all paragraphs containing text which include the string “IBM” (and all children markups within these paragraphs) to be kept, except for image tags which will be removed, is provided in FIG. 8. Notice that <push> and <pop> are used to override and restore the annotation state outside the bounds of these paragraphs. This example illustrates use of the take-effect-before and take-effect-after tags to specify annotations both before and after the pinpointed location, respectively, as was discussed earlier. Therefore, this example combination of push and pop tags and take-effect tags is specified such that annotation 810 has no effect on any portion of the input document except paragraphs which match the target attribute. (Note that the XPath specification in this example uses the contains function, because it is not significant for this example where in the text the string “IBM” occurs and because for purposes of the example, the searched-for characters can be constrained to a case-sensitive match. If a particular location, the case of the characters, or the presence of particular surrounding characters or symbols is significant, then the globb-match function disclosed herein may be used instead.)

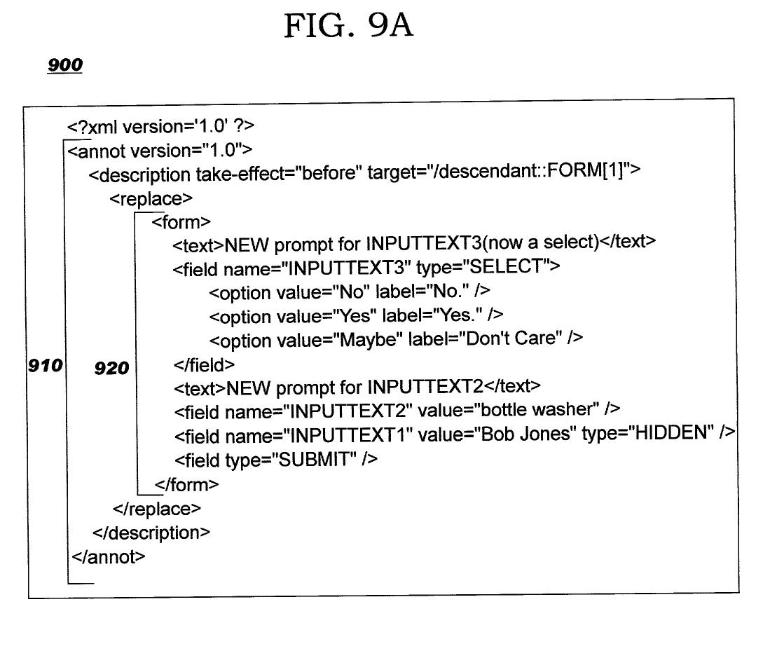

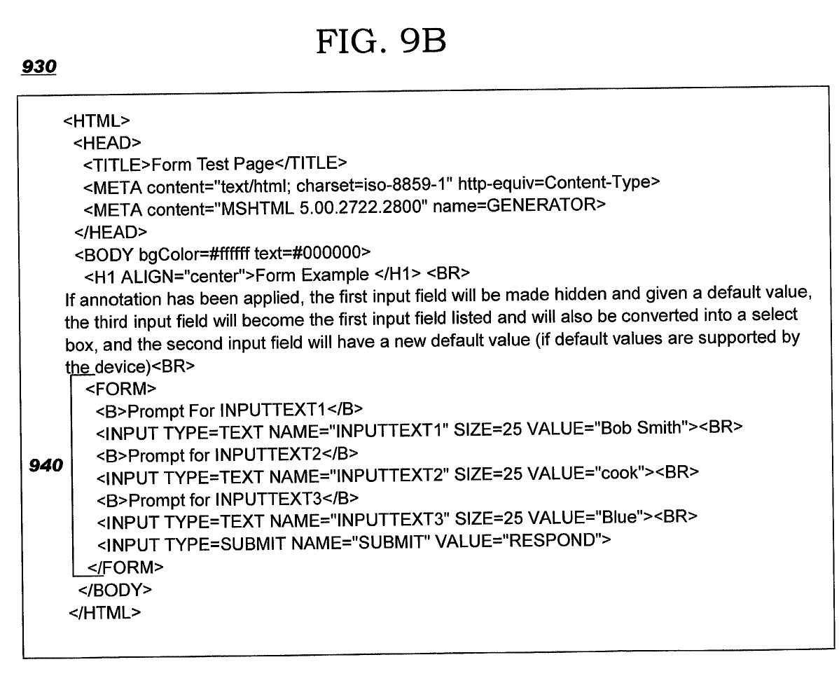

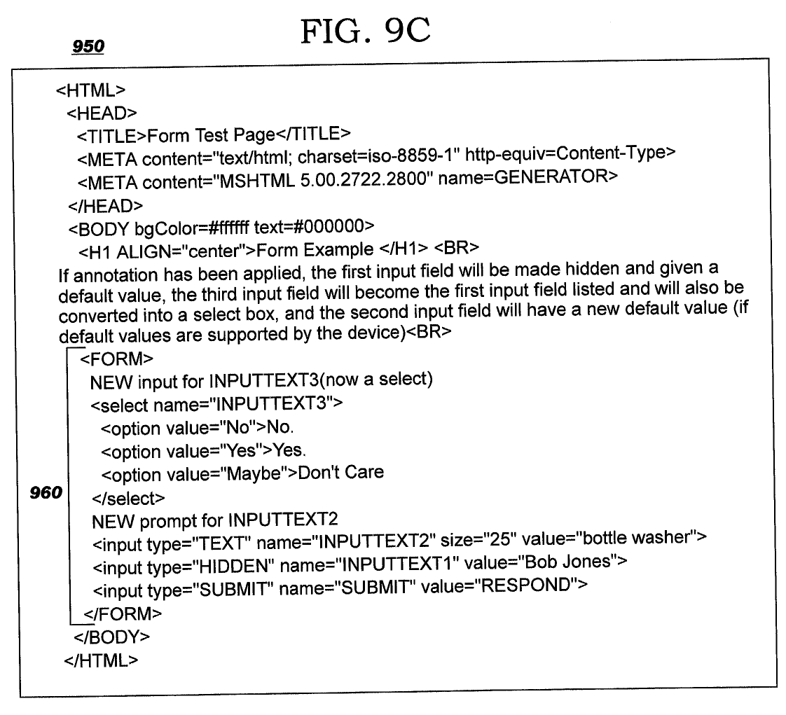

The second annotation feature, enhanced form support, is useful because in some cases, the techniques for automatically transcoding an HTML form lead to undesirable results. As stated earlier, labels that are beneath the text field they reference cannot be viewed easily when automatically transcoded to HDML. Furthermore, in order to transcode to certain markup languages such as VoiceXML, it is desirable that forms be composed of select boxes instead of text fields because enumerated inputs are better suited for voice recognition. (VoiceXML is an extension of XML that uses voice recognition and/or voice synthesis to interact with structured document content, and is known in the art.) This annotation feature enables form enhancements to be programmatically included in a page being prepared for transcoding, and permits new labels to be provided for input fields. In addition, the new labels may be positioned properly with reference to the input fields. Input fields may also be reordered, made hidden, and/or given default values. This annotation feature also permits text fields to be converted into select boxes by providing a supplemental list of options to be used in the creation of the select box. An example of using enhanced form support annotations is shown in the annotation file 900 of FIG. 9A. When used with the form 940 in source file 930 of FIG. 9B, the annotation 910 completely replaces the existing form. The markup syntax 920 of a new form which is specified as a subtree in annotation 910 is then inserted in place of the existing form 940, and after processing this annotation, the document 950 shown in FIG. 9C results. The result document contains the new form 920, as shown at 960. (Note that while preferred embodiments support all of the form transformations which have been discussed, alternative embodiments may support some subset thereof without deviating from the scope of the present invention. For example, an embodiment may choose to support converting text fields into select boxes but not default values for input fields.)

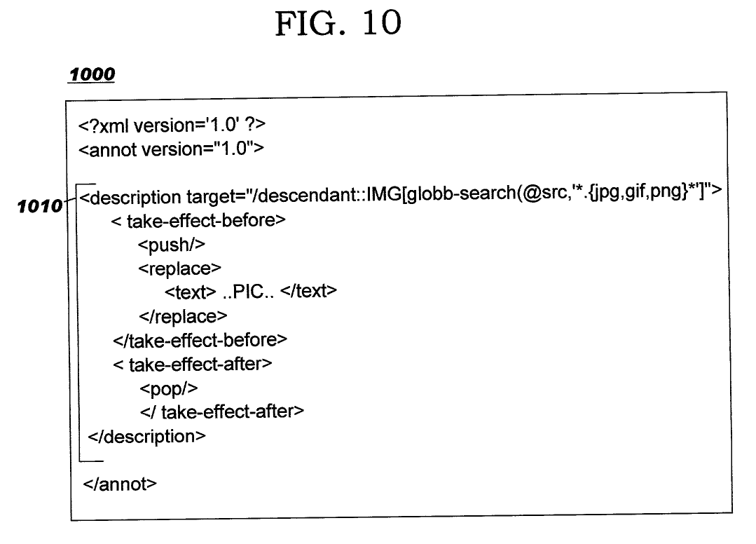

The third annotation feature is node and/or attribute replacement. In some cases, it is desirable for some of the HTML elements or attributes to be replaced with substitutes more appropriate for the target device (or other similar criteria). For example, in some situations, customers desire to replace image elements with text elements because images do not render well on some pervasive devices. This annotation feature enables HTML nodes from the original document to be replaced with new content from the annotation file and also permits attributes to be set with updated values. For example, the annotation 1010 in annotation file 1000 depicted in FIG. 10 may be used to replace all image nodes (that is, those images for which the value of the “src” attribute is one of “jpg”, “gif”, or “png”) with a node containing the text “. . . PIC . . . ”.

Fine-grained transcoding preference support is the fourth annotation feature discussed above. As one example of this type of fine-grained preference support, with HTML elements such as tables, there may exist several different viable transcoding approaches. For example, some tables may have been defined in a source document to mimic form-like layout, whereas other tables may have been designed to present tabular data and thus need their column labels preserved and emphasized as they proceed through the transcoding process. For these situations, this fine-grained transcoding annotation feature may be used to dynamically select the most appropriate transcoding approach for each table individually by inserting a transcoding “hint” into the file to be transcoded. This hint is then used by the transcoder to carry out the indicated type of table transcoding. As another example of fine-grained transcoding preference support, a transcoder may be adapted to search for image tags and modify those tags. Depending on a preference value, the transcoder might (1) omit all images; (2) leave all images untouched; or (3) change the image tags into links, so that the images are not displayed unless the user explicitly clicks on the link. (As will be obvious, the types of transcoding preferences that may be specified advantageously with the present invention depend on the capabilities and interface of the transcoder.)

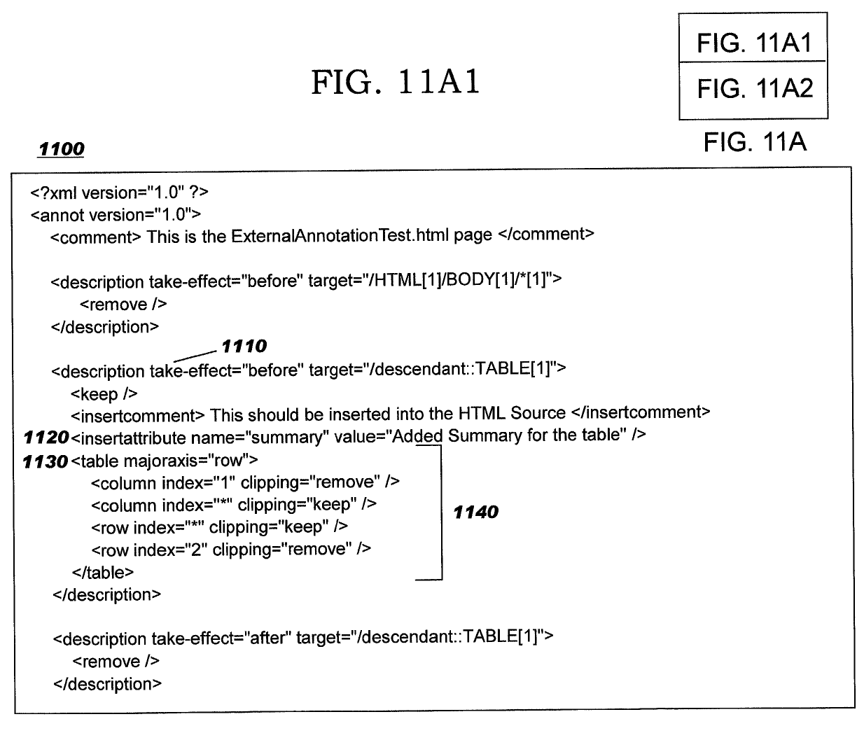

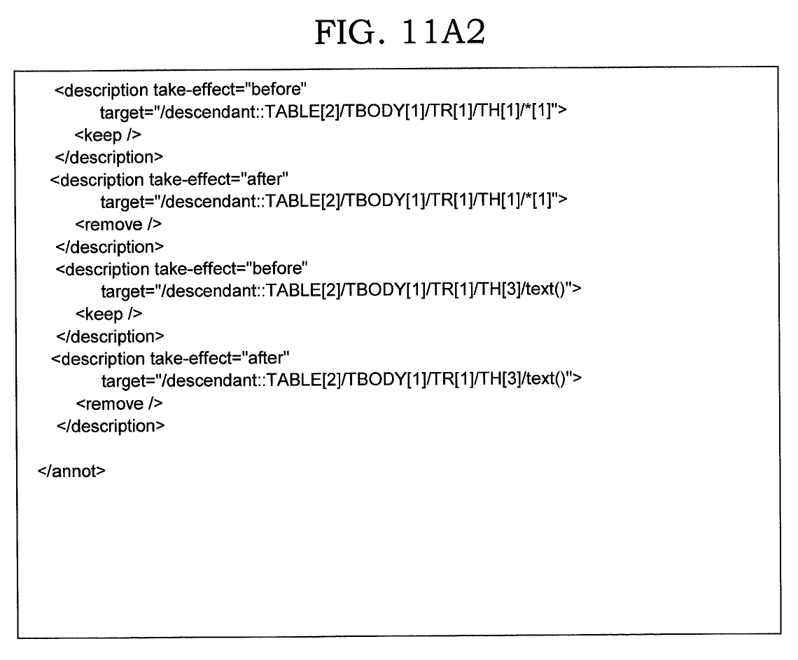

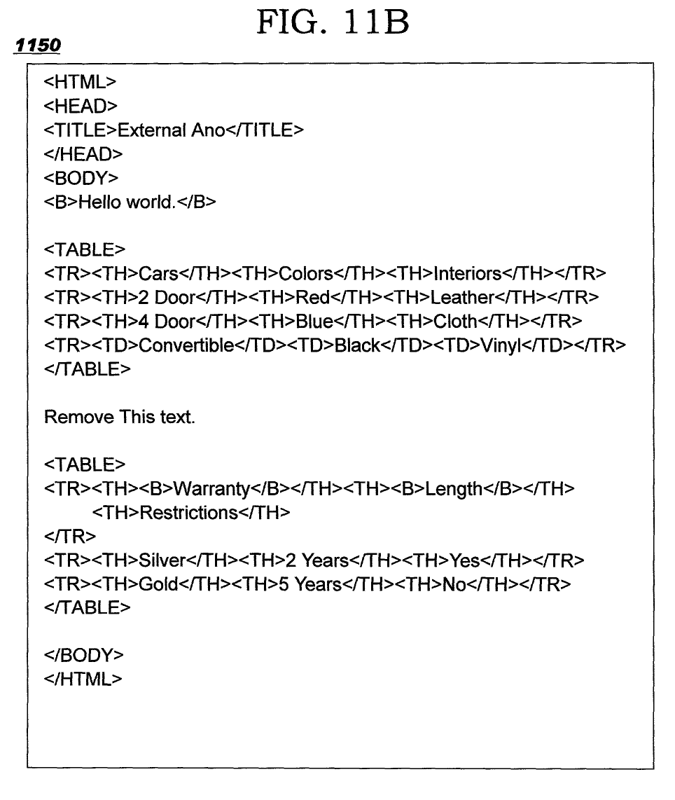

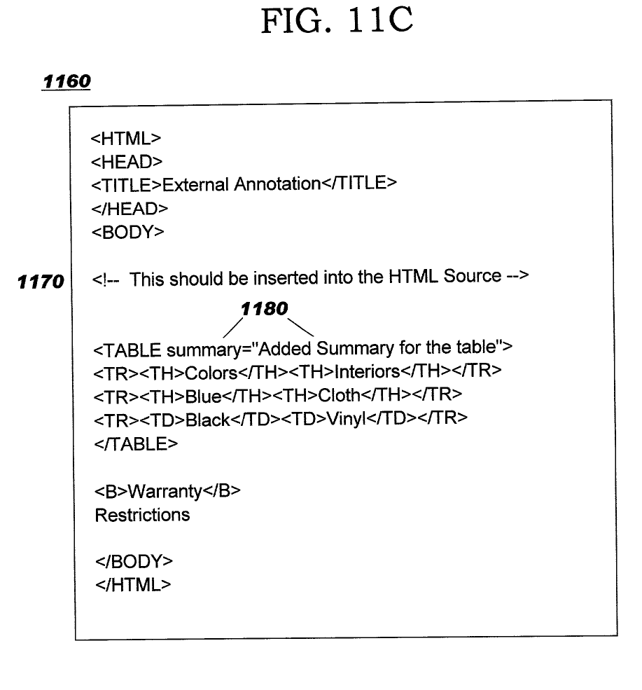

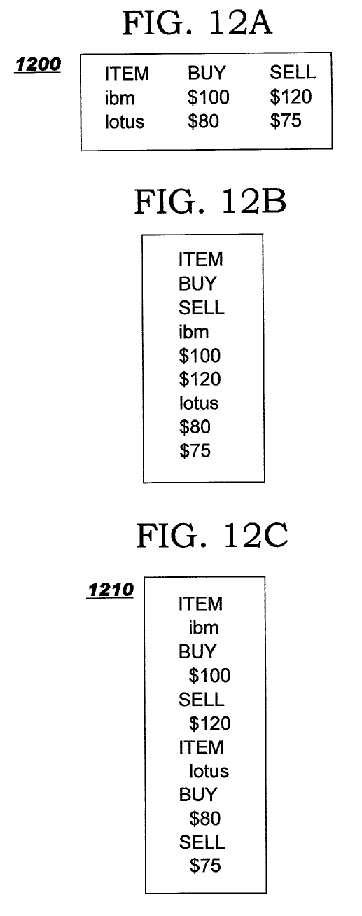

An example of using this annotation feature for table transcoding preferences is shown in annotation file 1100 of FIG. 11A. For example, before the first TABLE tag in the source document, the annotation described at 1110 specifies (1) a comment that is to be inserted (see 1120); (2) an attribute that is to be inserted, as well as the value to be used for that attribute (see 1130); and (3) how to restructure the table (see 1140). The restructuring of the table in this example comprises (1) applying the “majoraxis” specification, as described below; (2) removing column 1, while keeping all other columns; and (3) removing row 2 while keeping all other rows. The majoraxis attribute preferably takes values of either “column” or “row”. When specified, this attribute may be used to identify where the labels for a table are found. As an example, suppose the table 1200 in FIG. 12A occurred in a Web page. Commonly, transcoders will transcode tables into unordered lists for presentation on pervasive devices (which might not be able to properly display a table or its grid lines, for example). In this example, the first “row” of the table is actually comprised of text used as headings for the other rows. FIG. 12B shows how this table would look if a straight element-to-list-item conversion is performed during transcoding. If the table contains a number of entries, it may be quite difficult for the recipient of the list to determine how to correlate the table headings with the individual list items. Therefore, IBM's WebSphere Transcoding Publisher creates the list shown in FIG. 12C instead. The majoraxis=row” attribute may be used to specify that this table transcoding approach should be used. In this list 1210, the table entries from the table's major axis (i.e. its first row) have been replicated for each of the other table rows. In addition, the values from those other rows have been slightly indented, to visually set them off from their header. A similar list 1210 results if the input table aligns the headers down the first column, and WebSphere Transcoding Publisher is told that the table's major axis is a column. (In cases where a table has been used to mimic a form, then there is no major axis, and this attribute does not need to be supplied to the transcoder via a hint from an annotation.)

Referring again to FIGS. 11A-11C, when the annotation file 1100 is used with the source document 1150 of FIG. 11B, the document 1160 shown in FIG. 11C results after processing the annotations. According to preferred embodiments, the text from the insertcomment element 1120 appears as shown at 1170 after the annotation is processed, while the attribute name and value from 1130 appear in the resulting table as shown at 1180.

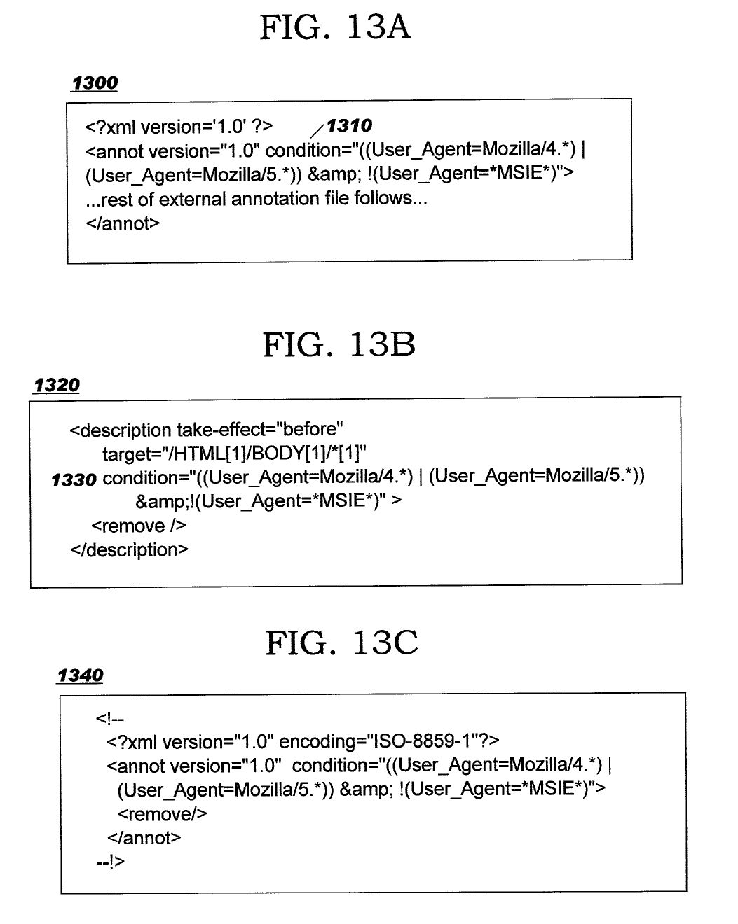

Conditional annotation, the fifth annotation feature, may be considered as an alternative technique to the characteristic marking which was previously described with reference to the match-key attribute. The feature preferably uses an additional attribute on the description tag of an annotation, and is illustrated in FIGS. 13A-13C. FIG. 13A shows how an entire annotation file 1300 may be marked as being conditional with a “condition” attribute 1310 on the <annot> tag, and in this example indicates that the file applies when the user agent field (e.g. of the HTTP header) contains the syntax “Mozilla/4.” or “Mozilla/5.”, but not when the user agent field contains the syntax “*MSIE*”. In FIG. 13B, syntax which may be used to show that an annotation is conditional is illustrated. In this annotation 1320, a condition attribute 1330 provides the same information as condition attribute 1310. In FIG. 13C, an example is illustrated wherein the same information is specified as a comment 1340 that might appear as an internal annotation. (Note that the syntax “&amp;” must be used instead of an ampersand symbol to specify an AND operation.)

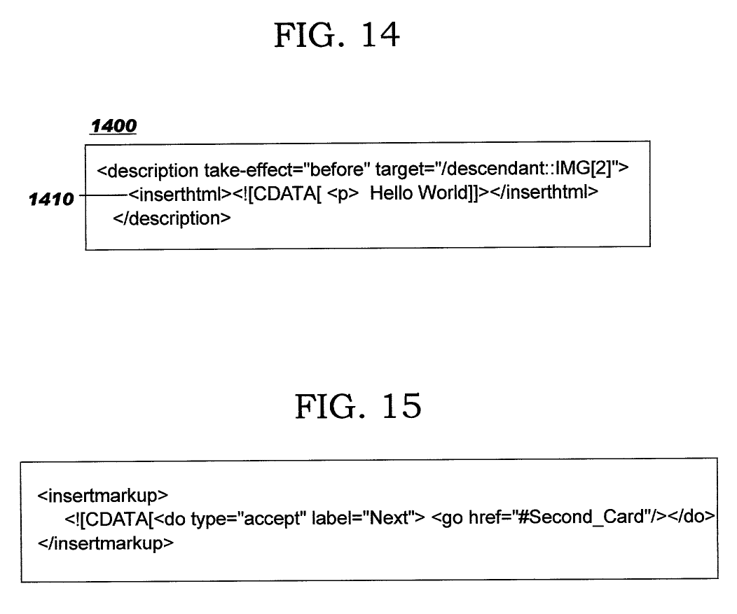

The insert HTML feature may be used to specify HTML markup that is to be inserted into a document. In preferred embodiments, the markup to be inserted is included within a CDATA section of an <inserthtml> element, thereby effectively hiding the HTML content from a parser (which would otherwise try to parse the markup). An example of using this feature in an annotation 1400 is illustrated in FIG. 14 (see 1410), where the markup “<p> Hello World” is to be inserted before the second image file of a document being annotated. Use within an internal annotation is similar.

The seventh annotation feature discussed earlier is inserting rendered markup. This feature may be used to insert another markup language into an HTML document, and enables specifically tailoring portions of the document for the target markup language. For example, if it is known that the document will be transcoded and rendered on a device that supports WML, then WML-specific markup may be inserted; or, if the device supports HDML, then HDML-specific markup may be inserted instead. An example of WML markup that might be inserted into a document to affect the transcoding of a WML deck is shown in FIG. 15.

Other types of annotation features may be used with implementations of the present invention, once the inventive concepts disclosed herein are known.

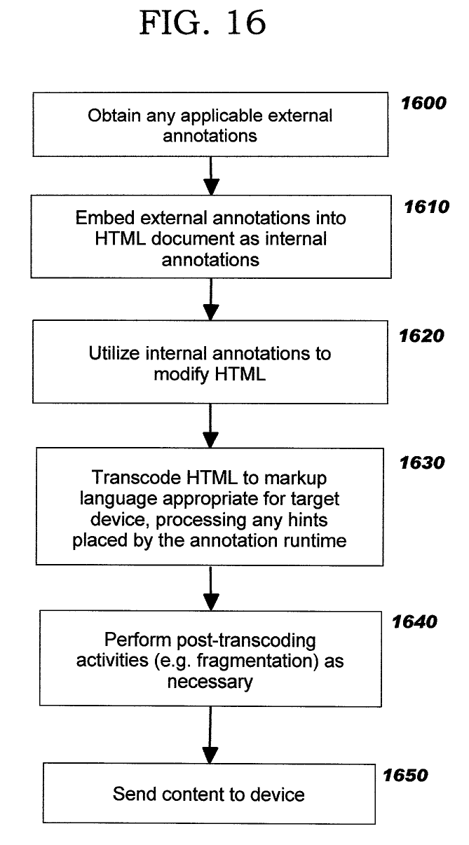

A high-level view of logic underlying the process for utilizing annotation to enhance transcoding according to the present invention is depicted in FIG. 16. If internal annotations have already been inserted into a source document, the process shown in FIG. 16 may begin at Block 1620. Or, the processing may begin at Block 1600 in order to merge any applicable external annotations into the document along with the internal annotations. The following discussion assumes the latter case.

First, in Block 1600 any annotations from external annotation files which are to be used for the source document (which may already contain internal annotations) are obtained, filtered by characteristics if applicable (as discussed with reference to FIG. 6). The “Using Annotations” document in Appendix A describes a registration process that may be used, if desired, to explicitly identify which annotation files should be considered for application to specific HTML source documents. Alternatively, available annotation files may be evaluated to determine their applicability to the source document. In addition, the previously-described technique of marking annotation files with characteristics pertaining to their applicability may be used. Finally, the HTML source file could also contain a reference to the associated external annotation file. (This latter technique might be advantageous, for example, if a content owner prefers features and/or tools for using external annotations over those of internal annotations.)

In Block 1610, the applicable external annotations are converted into internal annotations. Converting the external annotations into internal annotations includes addition of HTML comment syntax that will surround the annotation once it is embedded. The XPath and take-effect attribute or tag associated with the external annotations are utilized to determine where to embed the external annotations into the document in this process. Once all annotations have been embedded into the document, the annotation run-time engine can process the annotated document (Block 1620), thereby modifying the original HTML content into HTML that is better suited for the automatic transcoding techniques about to occur. These techniques are described in more detail below. (When an annotation being converted into an internal annotation includes a match-key attribute and one or more characteristic key-value pairs, then the key-value pairs may be evaluated before deciding if the annotation should be included in the document. In addition, such key-value pairs may be evaluated at run time when the annotation engine operates upon the annotations, in order to obtain the proper values for the keys.) Next, the modified HTML is passed to the transcoding subsystem which performs the actual content adaptation appropriate for the target device (Block 1630), using any hints that the annotation engine has placed into the document being transcoded. Finally, any necessary post-transcoding activities (e.g. fragmentation of content) are performed (Block 1640) and the content is sent to the target device (Block 1650).

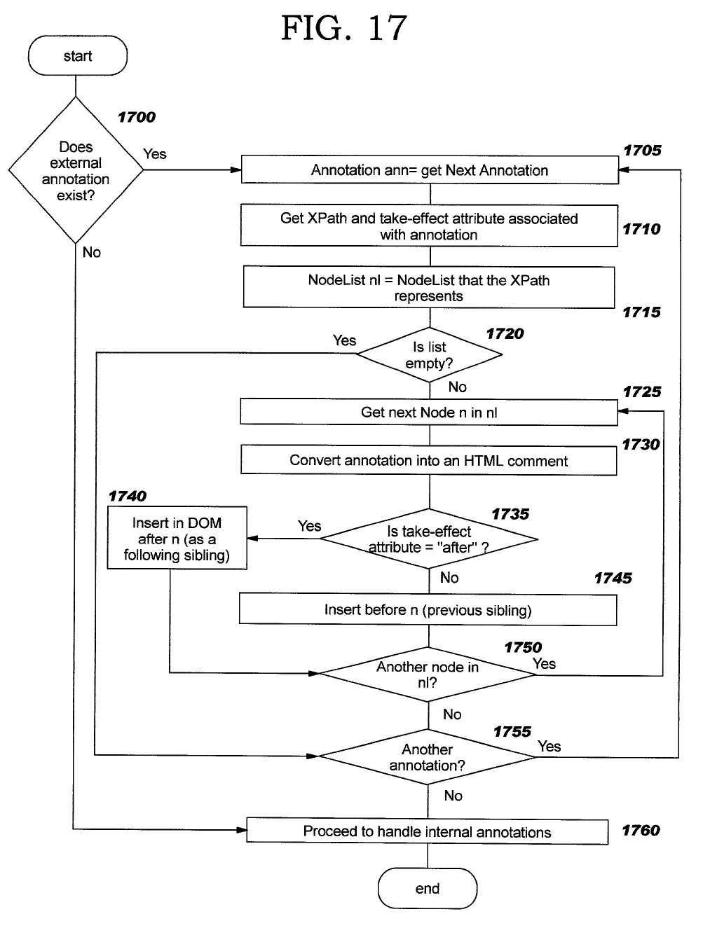

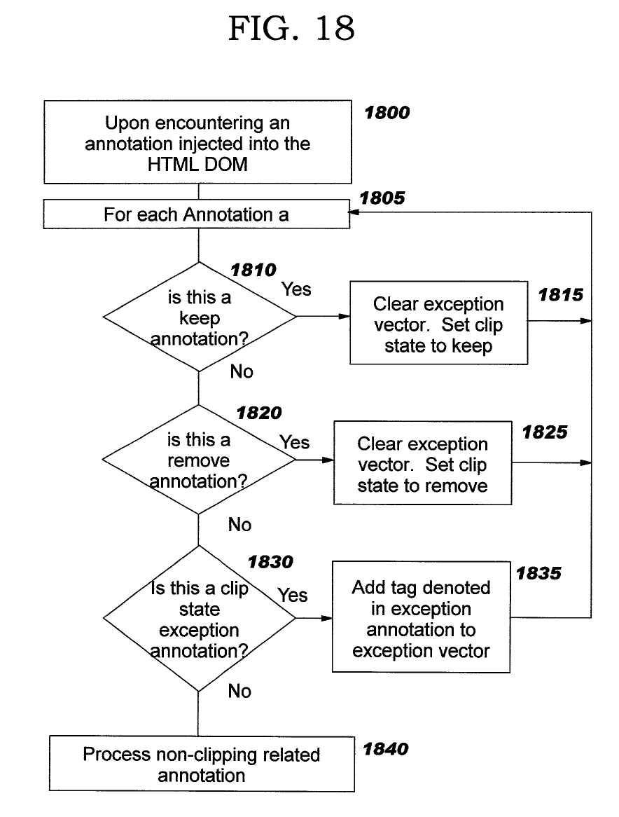

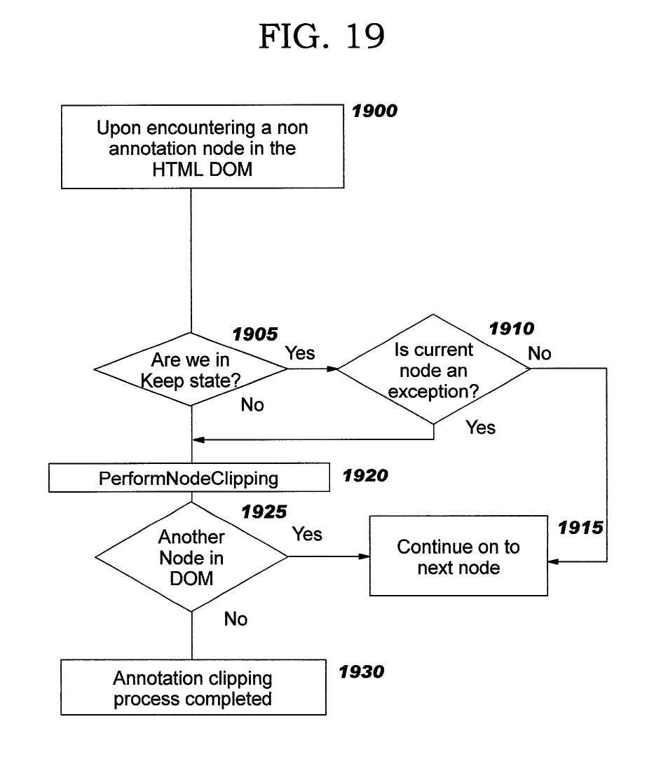

FIG. 17 illustrates logic which may be used to implement the process of embedding annotations into a source document, and expands upon Block 1610 of FIG. 16. Block 1700 checks to see if there is an external annotation. If not, then control transfers to Block 1760, where the embedded internal annotations (including those embedded by iterating through the logic of FIG. 17) are handled, as described in more detail in FIGS. 18 through 20. Otherwise, when there is an external annotation to process, Block 1705 gets the next annotation and assigns it to a variable referred to in FIG. 17 as “ann”. Block 1710 then gets the XPath target and the take-effect attribute information associated with this annotation. Block 1715 creates a list “n1” containing all the nodes which are represented by the XPath specification. If this list is empty (i.e. there was no match), then the test in Block 1720 has a positive result, causing control to transfer to Block 1760. Otherwise, processing continues at Block 1725. Block 1725 obtains the next node ‘N’ in the node list, and begins an iterative process that applies to each such node. The annotation is first converted into an HTML comment syntax (Block 1730). Block 1735 then checks to see if the take-effect attribute (or tag, when a separate tag is used) for this annotation has the value “after”. If so, then Block 1740 inserts the commented annotation syntax into the DOM after node “n” (i.e. as a following sibling); otherwise, Block 1745 inserts the commented annotation syntax into the DOM before node “n” (i.e. as a previous sibling). In either case, Block 1750 then checks to see if there are any more nodes in node list “n1”. If so, control returns to Block 1725 to begin processing the next node, and if not, control transfers to Block 1755.

Block 1755 checks to see if there are any more annotations in the current annotation file. (Note that when multiple annotation files are to be applied to a single source document, then this test also comprises determining whether any such additional files exist. Al applicable annotations should be embedded into the source document before processing any of them, in order to preserve the node structure for which the XPath specifications were designed.) If so, control returns to Block 1705 to begin processing the next annotation, and if not, then control reaches Block 1760 which has been previously described. Following completion of Block 1760, the annotation process for this source document is complete.

FIG. 18 illustrates logic which may be used by the annotation engine to process an annotation node; logic which may be used to process non-annotation nodes is described in FIG. 19. Block 1800 is reached when an annotation node is encountered in the HTML DOM (where this annotation node has been injected into the DOM according to the logic of FIG. 17, or as a result of building the DOM for a source file which included internal annotation). Multiple annotation descriptions may be present in each annotation node (i.e. within each node that has been generated for a commented annotation), and thus Block 1805 begins an iterative process which is performed for each such annotation. At Block 1810, a test is made to determine whether this is a “keep” annotation (i.e. an annotation corresponding to a “<keep>” tag with no attributes). If so, then Block 1815 clears an exception vector which is used in preferred embodiments to remember those tags from the source file which are to be treated as exceptions to the current clipping state, and sets the current clipping state to keep. Control then transfers back to Block 1805 to process the next annotation from this node, if any.

When the test in Block 1815 has a negative result, then a test is made is Block 1820 to see if this is a “remove” annotation (i.e. an annotation corresponding to a “<remove>” tag with no attributes). If so, then Block 1825 clears the exception vector, and sets the current clipping state to remove. Control then transfers back to Block 1805 to process the next annotation from this node, if any.

When the test in Block 1825 has a negative result, then Block 1830 checks to see if this is a clipping state exception annotation (i.e. an annotation corresponding to a “<remove>” tag with attributes when the current clipping state is “keep”, and vice versa). If so, then Block 1835 adds the tag name which was specified as the value of the corresponding tag attribute to the exception vector and sets the clipping state, and control transfers back to Block 1805.

When the tests in all of Block 1810, 1820, and 1830 have negative results, then this annotation is not related to clipping. For example, it may be an attribute-setting annotation, or an annotation to modify a form or table. Block 1840 invokes the proper logic to handle these types of non-clipping annotations, after which control transfers back to Block 1805. (It will be obvious to one of skill in the art how the DOM manipulating logic invoked from Block 1840 may be carried out.)

When no more annotations remain to be processed from the annotation node, the processing of FIG. 18 exits.

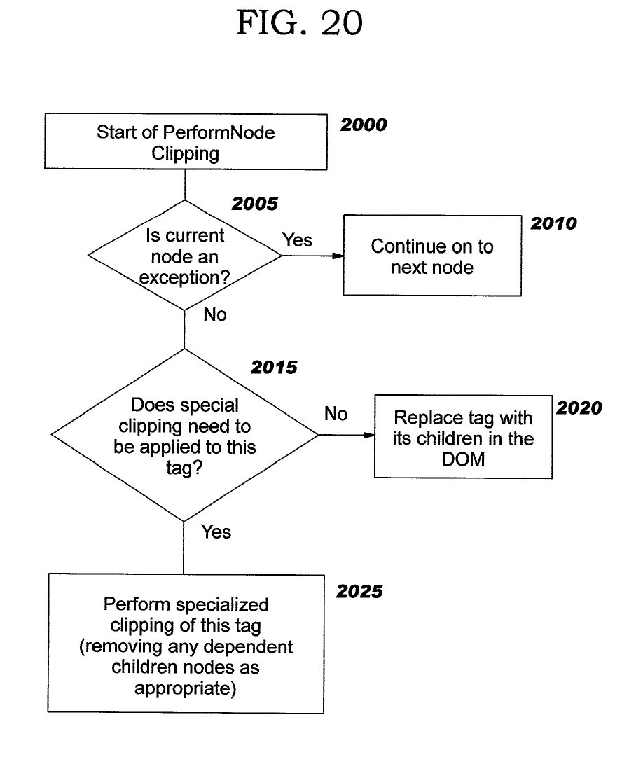

Block 1900 is reached when a non-annotation node is encountered in the HTML DOM. Block 1905 checks to see if the current clipping state is “keep”. if so, then Block 1910 compares the node to the exception vector to see if this node is to removed. If not, then control transfers to Block 1915, which simply continues on to the next node in the DOM. (That is, the non-annotation node is retained in the DOM.) When the test in Block 1905 has a negative result or the test in Block 1910 has a positive result, a node clipping process is performed, as indicated by Block 1920. This process is described in more detail with reference to FIG. 20. Upon completing the node clipping process, Block 1925 checks to see if there are any more nodes to be processed in the DOM. If so, then the next DOM node will be processed, as indicated by Block 1915; otherwise, the annotation clipping is complete for the annotated document represented by this DOM, as indicated at Block 1930.

FIG. 20 depicts logic which may be used to perform node clipping during the “remove” clipping state. Control reaches Block 2000 from Block 1920 of FIG. 19, after which Block 2005 checks to see if the current node is in the exception vector. If so, then control transfers to Block 2010, which simply continues on to the next node in the DOM. (That is, the non-annotation node is an exception to the remove state, and will be retained in the DOM.) Otherwise, Block 2015 checks to see if any special clipping should be applied to the tag contained in the DOM node. If not, then the tag is removed from the DOM, and its children (if any) are promoted to its previous level (Block 2010). The processing of FIG. 20 then ends for this node, returning control to Block 1925 of FIG. 19. When the test in Block 2005 has a positive result, Block 2015 indicates that the appropriate specialized clipping is performed, which may involve removing dependent children nodes from the DOM. For example, if an entire table is being removed, then any nodes corresponding to table row (“TR”), table column or heading (“TH”), or table definition (“TD”) tags should also be removed. Processing then returns to FIG. 19.

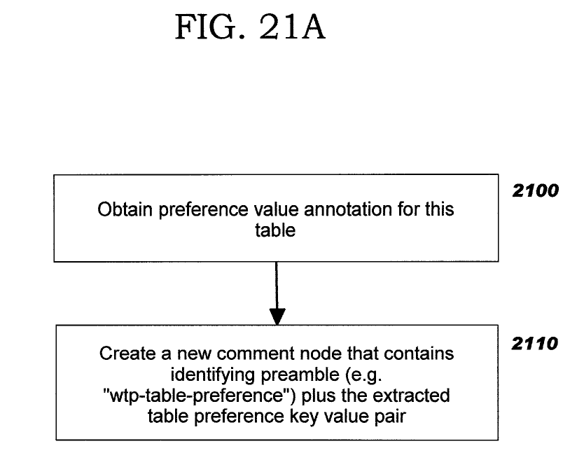

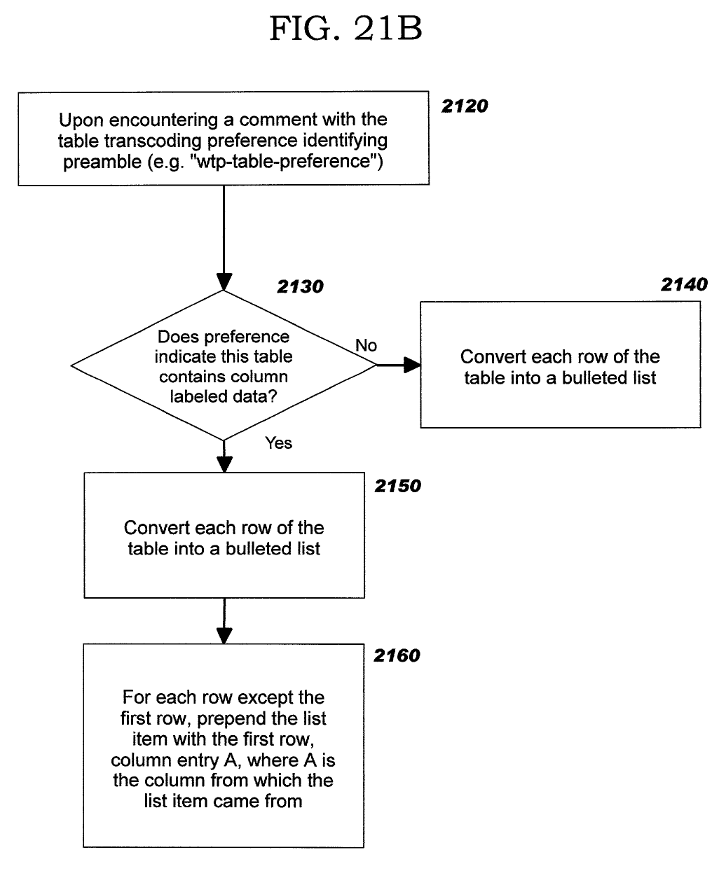

The flowcharts in FIGS. 21A and 21B illustrate in more detail how the table transcoding preference support discussed with reference to FIGS. 18A-18C may be implemented. FIG. 21A describes processing performed by the annotation engine to provide transcoding hints in documents containing tables, and FIG. 21B illustrates how a transcoder may react to those transcoding hints. At Block 2100, the preference annotation information (such as the major axis attribute in annotation 1840 of FIG. 18A1) is obtained. In response, a new comment node is created in the DOM (Block 2110), where this comment node preferably contains a keyword or otherwise syntax that enables easily determining that this is a transcoding hint. As shown in FIG. 21A, the syntax may be of a form such as “wtp-table-preference” as a preamble, followed by the key-value pair (i.e. the attribute name and value) from the annotation. In Block 2120 of FIG. 21B, the transcoder encounters a comment with the syntax inserted by Block 2110 of FIG. 21A. Block 2130 then checks to see if this comment syntax indicates that the table is to be treated as having a major axis where column labels have been placed in a row. If not, then Block 2140 indicates that the rows may simply be converted into a buffeted list; otherwise, control transfers to Block 2150. As Blocks 2150 and 2160 execute, each row of the table is converted into a bulleted list, but each row except the first (which contains the column labels) gets the column labels prepended in the manner which has been illustrated in FIG. 19C. (Alternatively, other techniques for replicating the column labels may be used, include a post-processing approach where the rows are marked for later insertion of the column labels.) Note that the keep and remove values of the “clipping” attribute for column and row tags which were illustrated in FIG. 18A1 are preferably handled in a similar manner to that which has been described with reference to FIGS. 18-20.

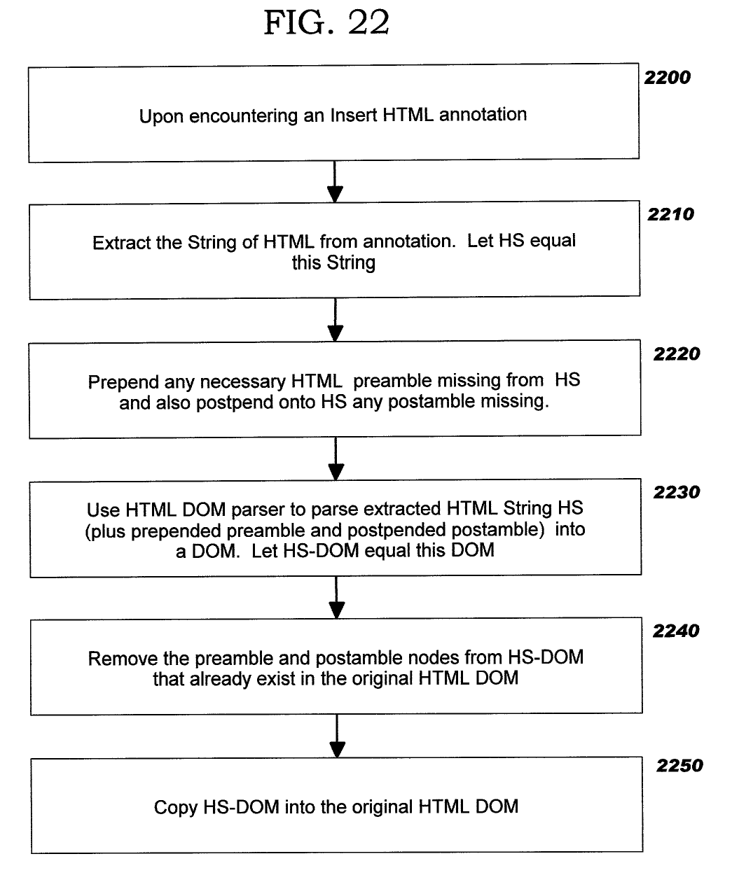

The logic in FIG. 22 describes the annotation engine processing which may be used to insert fragments of HTML markup into a document using the insert HTML feature, in order to improve transcoding of the document. When an annotation using this feature is encountered (Block 2200), the string of HTML markup is extracted therefrom (Block 2210) and stored as the value of a variable referred to in FIG. 22 “HS”. At Block 2220, any necessary HTML preamble is prepended to this string, and any necessary postamble or epilogue is also postpended. For example, suppose the HTML fragment shown as the value of tag 1410 of FIG. 14 is to be added to a document. A parser will expect, at a minimum, an <HTML> and <BODY> tag to precede the fragment in order to have proper HTML syntax, and will also expect closing tags of this type. Thus, Block 2220 adds these tags if they are not already present. In Block 2230, the HTML DOM parser parses the string HS (including its newly-added preamble and postamble, when applicable), creating a new DOM tree. A pointer which is referred to as “HS-DOM” in FIG. 22 is set to point to this DOM tree. Block 2240 then removes any of these preamble and postamble tags which are already present in the original DOM of the document into which the HTML fragment is to be inserted. Finally, Block 2250 copies the HS-DOM into the original DOM.

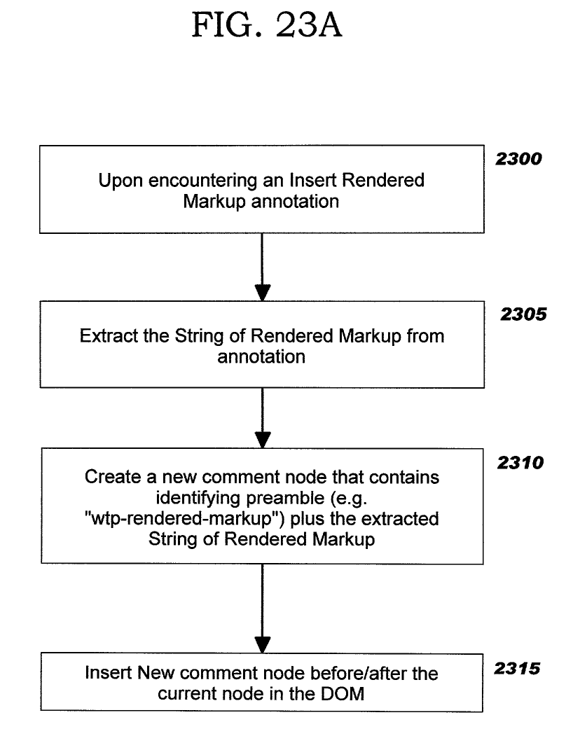

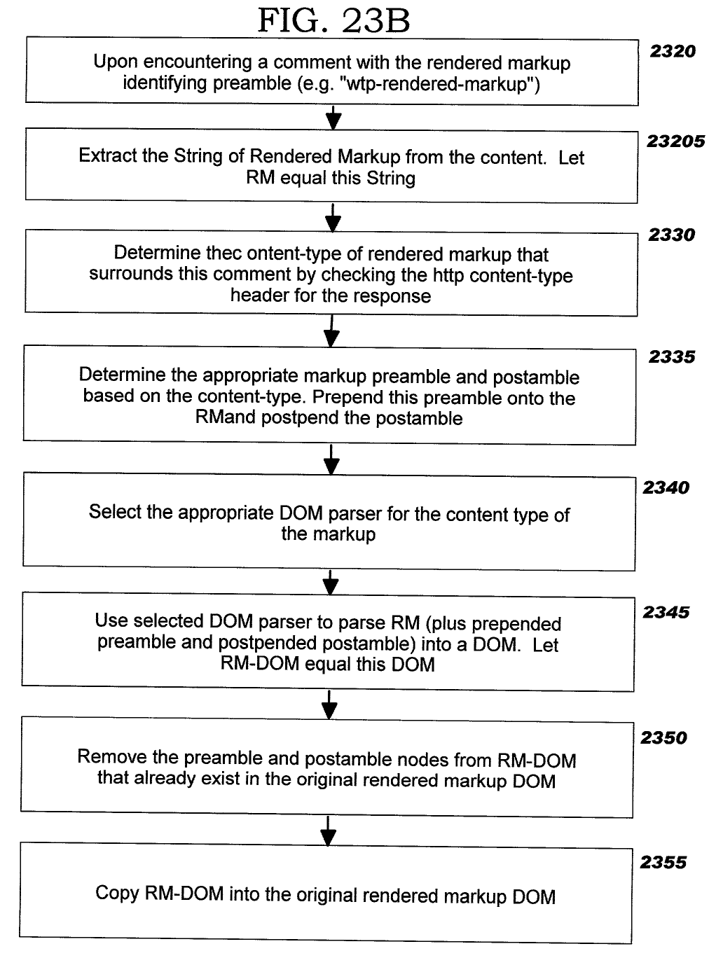

The flowcharts in FIGS. 23A and 23B illustrate how the insert rendered markup feature may be implemented. FIG. 23A describes processing performed by the annotation engine to insert the markup for this feature into a document being annotated, and FIG. 23B illustrates how a transcoder may react to this inserted information. Upon encountering an insert rendered markup annotation (Block 2300), the string of rendered markup is extracted therefrom (Block 2310). A new comment node is created in the DOM (Block 2320), where this comment node preferably contains a predetermined keyword or otherwise syntax. As shown in FIG. 23A, the syntax may be of a form such as “wtp-rendered-markup” as a preamble, followed by the extracted information from the annotation. This new comment node is then inserted into the DOM (Block 2315) before the current DOM node. In Block 2320 of FIG. 23B, the transcoder encounters a comment with the syntax inserted by Block 2315 of FIG. 23A. Block 2325 then extracts the rendered markup string from the comment, and stores it as the value of a variable referred to in FIG. 23 “RM”. At Block 2330, the content type that surround this rendered markup is determined (e.g. by checking the HTTP content-type header for the response message). Using this information, Block 2335 determines what preamble and postamble markup is necessary, and adds that to the string in RM (as has been described above with reference to Block 2220 of FIG. 22). Block 2340 selects the appropriate DOM parser (e.g. a WML parser, or an HDML parser), based on the content type. Using this selected parser, Block 2345 parses the contents of variable RM (including its newly-added preamble and postamble, when applicable), and creates a new DOM tree. A pointer which is referred to as “RM-DOM” in FIG. 23 is set to point to this DOM tree. Block 2350 then removes any of the preamble and postamble markup which is already present in the original DOM of the document into which the rendered markup is to be inserted. Finally, Block 2355 copies the RM-DOM into the original DOM.

A number of specific problem areas with prior art automated transcoding techniques are improved through use of the annotation features disclosed herein. As has been demonstrated, the present invention provides a number of advantages over the prior art, including:

1) The use of annotation, as disclosed herein, results in transcoded content that is customized in a fashion desired by customers, yet still permits the customers to leverage automatic transcoding techniques.

2) Because annotation is applied before the content is transcoded into a device-specific markup language, a single annotation can be utilized for several different target devices. Furthermore, since in many cases annotation results in the clipping of the HTML content, it typically results in reducing the amount of content that needs to be passed to the transcoding engine and to the client device. This, in turn, typically results in reduced bandwidth requirements for the connection to the client (and to the transcoding engine, if the transcoding engine is located remotely from the annotation engine).

3) For HTML elements such as tables, where there may exist several different viable transcoding approaches, annotation may be used to declare which technique should be used on a per-table-element basis, thus providing a technique for very fine-grained transcoding support which is not possible with prior art techniques.

4) Annotations defined in external annotation files can be applied to dynamically-generated document content as well as to statically-generated content, and can be re-used by entire page families (where the documents in those page families satisfy the content pattern described in the XPath specification of the annotation's target attribute). Characteristic filtering, using the optional match-key attribute which has been described, allows a single set of annotations to be used in conjunction with multiple targets with a minimum of authoring effort. When the techniques described in U.S. Pat. No. ______ “Retrieval of Style Sheets from Directories Based Upon Partial Characteristic Matching”, are used within a site for describing applicability of style sheets, using characteristic information to mark annotations may be done in a consistent fashion with the site's styling.

A paper titled “Annotation-Based Web Content Transcoding” by Masahiro Hori, Goh Kondoh, Kouichi Ono, Shin-ichi Hirose, and Sandeep Singhal was presented at the WWW9 Conference in Amsterdam, May 15-19, 2000. This paper takes a divergent view of annotation in that it is predicated on a view that mixing transcoding hints into a source file, thereby creating an annotated file, “would not be acceptable” based on a design consideration the authors adopted from a presentation cited as reference #18 in the paper. Additionally the authors, in their view of external annotation, adopted an indeterminate hinting technique which provides an analog “priority” value (that is, a priority value ranging between −1 and 1). A content developer assigns a priority value to a particular document element to be hinted. The paper illustrates a WYSIWYG editor which is designed for providing hints of this type. The hints are stored in an external file, and are interpreted by a transcoder which is specially adapted for processing the hints during transcoding. (In other words, the hints as defined in this paper require additional un-described information and/or logic to be useful to the transcoder). In contrast, the present invention defines a technique which may be used with existing transcoders. (Note that the hints which are placed into files to be transcoded, such as the “majoraxis=row” attribute described with reference to FIGS. 18 and 19, are a type of information supported by existing transcoders.) This paper describes an identification scheme where the identity of the HTML to be hinted relies on the identity of the surrounding mark-up, which means that the external annotations can only apply to statically-generated HTML. (That is, a change to the mark-up of non-hinted parts of the base document requires the identification information in the external annotations to be changed. Because the described scheme has no counterpart to a “take-effect” clause (i.e. take-effect-before and/or take-effect-after tags) as described herein, two different XPath expressions would be required in order to provide boundaries for a hinted area, and one of these expressions must be inside the hinted content and therefore dependent on that content. The technique of the present invention, on the other hand, is much more flexible and allows (1) a single XPath expression within a hinted area to bound the area, (2) two XPath expressions both outside a hinted area to bound the area, (3) two XPath expressions both inside a hinted area to bound the area, or (4) two XPath expressions, one inside and the other outside and either preceding or following the area). No techniques are disclosed in this paper for use with dynamically-generated content, nor for conditionally applying annotations or for inserting additional elements and/or attributes into a document. The present invention provides these capabilities, as has been described above (see, e.g., the <push> and <pop> constructs and the “match-key” attribute discussions). Furthermore, the approach described in the paper has no counterpart to the insertion of HTML and insertion of rendered markup techniques which are disclosed herein, nor does it provide for fine-grained transcoding. A very complete set of prior art references are provided in this paper, which can be found on the Web at http://www9.org/w9cdrom/169/169.html.

U.S. Pat. No. ______ (Ser. No. 09/417,880, filed Oct. 13, 1999), which is titled “Achieving Application-Specific Document Content by Transcoding using Java Server Pages” disclosed a transcoding hinting technique for both HTML and XML Java Server pages authors which could flow in-band (within the respective markup language; for HTML, this was within comment text) over the network to remotely located transcoders. The annotation hints described therein were aimed at optimizing the selection of format conversion and styling instructions rather than at the pre-transcoding process of optimizing the application native markup (e.g. optimizing transcoding of the HTML elements). Also, this U.S. patent did not address utilizing external annotation to augment the in-band hints.

As will be appreciated by one of skill in the art, embodiments of the present invention may be provided as methods, systems, or computer program products. Accordingly, the present invention may take the form of an entirely hardware embodiment, an entirely software embodiment or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowcharts and/or block diagrams of methods, apparatus (systems) and computer program products according to embodiments of the invention. It will be understood that each flow and/or block of the flowcharts and/or block diagrams, and combinations of flows and/or blocks in the flowcharts and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart diagram flow or flows and/or block diagram block or blocks.

While preferred embodiments of the present invention have been described, additional variations and modifications in those embodiments may occur to those skilled in the art once they learn of the basic inventive concepts. Therefore, it is intended that the appended claims shall be construed to include both preferred embodiments and all such variations and modifications as fall within the spirit and scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of enhancing document transcoding, comprising steps of:
specifying one or more annotations; and
inserting one or more selected ones of the specified annotations in an a particular document, thereby preparing the particular document for enhanced transcoding.

2. The method according to claim 1, wherein the including step occurs programmatically.

3. The method according to claim 2, further comprising the step of transcoding the particular document using the inserted annotations.

4. The method according to claim 1, wherein at least one of the specified annotations is specified separately from the particular document.

5. The method according to claim 1, wherein at least one of the specified annotations is specified inline within the particular document

6. The method according to claim 1, wherein at least one of the specified annotations requests clipping content from a document.

7. The method according to claim 1, wherein at least one of the specified annotations describes changes to one or more form elements in a document.

8. The method according to claim 1, wherein at least one of the specified annotations prescribes one or more nodes to be replaced in a document.

9. The method according to claim 1, wherein at least one of the specified annotations specifies one or more (attribute name, attribute value) pairs to be inserted into a document.

10. The method according to claim 1, wherein at least one of the specified annotations specifies fine-grained transcoding preferences to be inserted into a document.

11. The method according to claim 10, wherein the fine-grained transcoding preferences pertain to a table in the document.

12. The method according to claim 1, wherein at least one of the specified annotations includes conditional syntax stating when the at least one annotation is to be inserted into a document.

13. The method according to claim 1, wherein at least one of the specified annotations prescribes Hypertext Markup Language (“HTML”) syntax to be inserted into a document.

14. The method according to claim 1, wherein at least one of the specified annotations prescribes rendered markup language syntax to be inserted into a document.

15. The method according to claim 1, wherein a location where each of the selected annotations is to be inserted is specified as an attribute of that annotation.

16. The method according to claim 15, wherein the location is expressed using positional information that is based upon target tags in a target document.

17. The method according to claim 16, wherein the positional information enables case-insensitive matching of text in the target document.

18. The method according to claim 16, wherein the positional information enables the inserting step to operate with statically-generated document content as well as with dynamically-generated document content.

19. The method according to claim 17, wherein the text is to appear as a tag in the target document.

20. The method according to claim 17, wherein the text is to appear as an attribute value in the target document.

21. The method according to claim 15, wherein a definition of the annotation indicates whether the annotation should be inserted before or after the location.

22. The method according to claim 6, wherein the at least one specified annotation further specifies one or more exceptions to the clipping of the content.

23. The method according to claim 11, wherein the at least one specified annotation further specifies one or more rows and/or columns to be clipped from the tables.

24. The method according to claim 1, wherein a definition of a particular one of the specified annotations states at least one (key, value) pair that indicates when this particular annotation is applicable.

25. The method according to claim 1, wherein an annotation file in which at least one of the specified annotations is stored has an associated (key, value) pair that indicates when this annotation file is applicable.

26. The method according to claim 15, wherein the location is expressed using XPath notation.

27. A method for annotating structured documents, comprising steps of:
receiving a request for a structured document;
locating one or more annotation files which contain annotations which are pertinent to the request; and
inserting the pertinent annotations into the structured document, thereby creating an annotated document.

28. The method according to claim 27, further comprising the steps of:
applying the annotations in the annotated document, thereby creating a modified document; and
transcoding the modified document, thereby creating a transcoded document.

29. The method according to claim 28, further comprising the step of sending the transcoded document to a device which issued the request.

30. A method for improved transcoding of structured documents, comprising steps of:
receiving a request for a structured document;
locating one or more annotation files which contain annotations which are pertinent to the request;
applying the pertinent annotations to the structured document, thereby creating a modified document; and
transcoding the modified document, thereby creating a transcoded document.

31. A system for improved transcoding of structured documents, comprising:
means for receiving a request for a structured document;
means for locating one or more annotation files which contain annotations which are pertinent to the request;
means for applying the pertinent annotations to the structured document, thereby creating a modified document; and
means for transcoding the modified document, thereby creating a transcoded document.

32. A computer program product for improved transcoding of structured documents, the computer program product embodied on one or more computer-readable media and comprising:
computer-readable program code means for receiving a request for a structured document;
computer-readable program code means for locating one or more annotation files which contain annotations which are pertinent to the request;
computer-readable program code means for applying the pertinent annotations to the structured document, thereby creating a modified document; and
computer-readable program code means for transcoding the modified document, thereby creating a transcoded document.
